(19) United States
(12) Patent Application Publication
(10) Pub. No.: US 2026/0367865 A1
(43) Pub. Date: Nov. 19, 2026

(54) MICROPHONE SWITCHING FOR TRANSLATIONS

(71) Applicant: Apple Inc., Cupertino, CA (US)

(72) Inventor: Ashok MASILAMANI, San Diego, CA (US)

(21) Appl. No.: 19/566,962

(22) Filed: Mar. 13, 2026

Related U.S. Application Data
(60) Provisional application No. 63/806,596, filed on May 15, 2025.

(51) Int. Cl. G06F 3/16; G06F 40/58; G10L 13/027; G10L 13/033; G10L 21/0216; G10L 25/84; H04R 3/00; H04R 29/00; H04S 7/00; G10L 21/0208

(52) U.S. Cl. CPC G06F 3/165; G06F 3/162; G06F 40/58; G10L 13/027; G10L 13/033; G10L 21/0216; G10L 25/84; H04R 3/005; H04R 29/004; H04S 7/30; G10L 2021/02082; H04S 2400/11; H04S 2400/15

(57) ABSTRACT

Aspects of microphone switching for translation are described. An input controller at an electronic device may control which, if any, of multiple microphone signals from multiple microphones is provided to a translator application for translation of speech represented in the microphone signals. This control of the input to the translator application may be based on the quality and/or content of the microphone signals, the presence of a user’s own voice in the microphone signals, a state of the translator application, and/or a state of the electronic device.

### CROSS REFERENCE TO RELATED APPLICATION(S)

The present application claims the benefit of U.S. Provisional Application No. 63/806,596, entitled “MICROPHONE SWITCHING FOR TRANSLATIONS”, filed May 15, 2025, the entirety of which is incorporated herein for reference.

### TECHNICAL FIELD

The present description relates generally to audio devices and, more particularly, for example, to microphone switching for translations.

### BACKGROUND

Electronic devices are sometimes provided with translation applications that can translate written text in one language to written text in another language. Some translation applications can translate spoken speech in one language into written text in another language.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 is a schematic diagram illustrating a use case in which a translation operation involving multiple microphones of multiple respective devices is performed in accordance with implementations of the subject technology.

FIG. 3 is a schematic diagram illustrating another use case in which a translation operation involving multiple microphones of multiple respective devices is performed in accordance with implementations of the subject technology.

FIG. 4 is a schematic diagram illustrating an electronic device performing a translation operation in accordance with one or more implementations of the subject technology.

FIG. 5A is a timing diagram illustrating example inputs to a translation application in a first use case with overlapping speech in accordance with one or more implementations of the subject technology.

FIG. 5B is another timing diagram illustrating example inputs to a translation application in the first use case with overlapping speech in accordance with one or more implementations of the subject technology.

FIG. 6 is a timing diagram illustrating inputs to a translation application in a second use case with overlapping speech in accordance with one or more implementations of the subject technology.

FIG. 7 is a schematic diagram illustrating an electronic device performing a two-way translation operation in accordance with one or more implementations of the subject technology.

FIG. 8 is a timing diagram illustrating an electronic device controlling inputs to a translation application in a two-way translation use case with overlapping speech in accordance with one or more implementations of the subject technology.

FIG. 9 illustrates an example electronic device providing a notification in accordance with one or more implementations of the subject technology.

FIG. 10 is a flow diagram for an example process for microphone switching for translations in accordance with one or more implementations of the subject technology.

FIG. 11 is a flow diagram for an example process for performance translation in accordance with one or more implementations of the subject technology.

FIGS. 12A and 12B illustrate aspects of an example of dynamic control of a field-of-view of a beam for processing microphone signals in accordance with one or more implementations of the subject technology.

FIGS. 13A and 13B illustrate aspects of another example of dynamic control of a field-of-view of a beam for processing microphone signals in accordance with one or more implementations of the subject technology.

FIG. 14 is a flow diagram for an example process for dynamic control of a field-of-view of a beam for processing microphone signals in accordance with one or more implementations of the subject technology.

FIG. 15 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Implementations of the subject technology described herein provide for dynamic control of an audio input to a translator application. For example, a translator application may run on an electronic device, and may be configured to generate a translated audio output responsive to receiving an audio input. Dynamic control of the audio input can help to provide the highest quality audio signal for translation, and/or to aid in providing more natural, conversation-style translation experience for the user.

For example, the audio input to a translator at a first device (e.g., a portable electronic device, such as a smartphone) may be switched between a first microphone signal from a first microphone of the first device, a second microphone signal of a second microphone of a second device (e.g., an audio output device, such as an earbud or a headphone, or a head mountable device), and/or no input. As discussed in further detail hereinafter, switching between the first microphone signal and the second microphone signal may help to provide the highest quality audio signal for translation by selecting the microphone that is physically closest to the person speaking and/or is position to receive the person’s speech along an unobstructed acoustic path. As discussed in further detail hereinafter, switching between the microphone signals and no signal may help to conserve processing and/or battery power while providing the more natural, conversation-style translation experience for the user.

The switching may be based on the first microphone signal, the second microphone signal, and/or other signals, such as contextual signals, and can be performed at various times throughout a translation session using the translation application. As examples, the switching may be based on a signal-to-noise ratio of one or both of the microphone signals, a noise level detected using one or both of the microphones, and/or based on a presence of the user’s own voice in one or both of the microphone signals. The switching can also be based on one or more other input selection criteria and/or signals, such as a state of the translator application on the first device, a physical state of the first device, a launch trigger of the translator application, and/or other criteria, which may be based on information from a processor and/or one or more sensors of the first device.

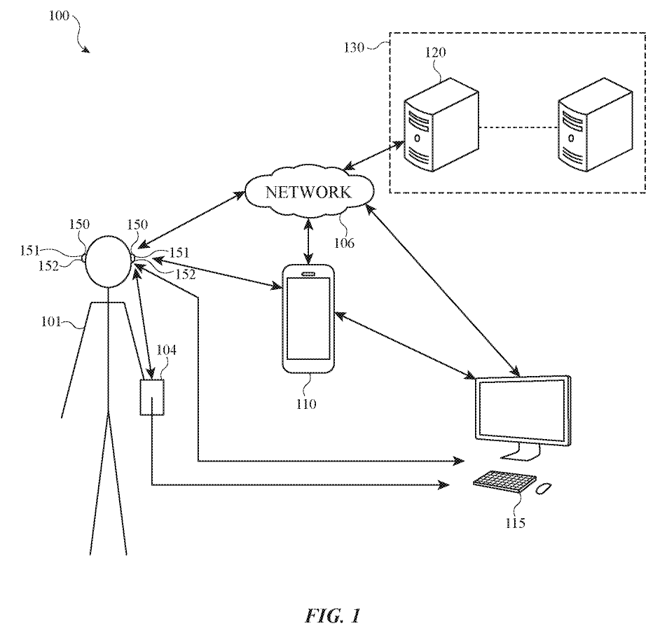

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio device 150, an electronic device 104 (e.g., a handheld electronic device such as a smartphone or a tablet), an electronic device 110, an electronic device 115, and a server 120 communicatively coupled by a network 106 (e.g., a local or wide area network). For explanatory purposes, the system architecture 100 is illustrated in FIG. 1 as including the audio device 150, the electronic device 104, the electronic device 110, the electronic device 115, and the server 120; however, the system architecture 100 may include any number of electronic and/or audio devices and any number of servers or a data center including multiple servers.

The audio device 150 may be implemented as headphones (e.g., a pair of speakers mounted in speaker housings that are coupled together by a headband) or an earbud (e.g., an earbud of a pair of earbuds each having a speaker disposed in a housing that conforms to a portion of the user’s ear) configured to be worn by a user (also referred to as a wearer when the audio device is worn by the user). Each audio device 150 may include one or more speakers, such as a speaker 152 configured to project sound into an ear of the user 101, and one or more sensors such as a sensor 151. Sensor 151 may include one or more microphones configured to receive audio inputs (e.g., based on a user’s own voice, environmental sounds, and/or other external voice inputs). Sensor 151 may include other sensors, such as inertial measurement unit (IMU) sensors (e.g., accelerometers, magnetometers, and/or gyroscopes). In one or more implementations, the audio device 150 may be integrated with and/or communicatively coupled with (e.g., and co-operable) with another device, such as a wearable device, such as smart watch, a smart ring, or a head mountable device (HMD) that includes one or more displays for displaying visual content (e.g. a movie, a show, other video content and/or gaming content) that corresponds to audio content being output by the audio device 150. In one or more implementations, when the audio device 150 is implemented as a head mountable device, the head mountable device may include one or more interfaces for mechanically coupling a housing thereof to one or more structures (e.g., straps, arms, or other attachment mechanisms) that are configured for securing the housing to a wearer (e.g., to a head of the wearer). In one or more implementations, a head mountable device may be implemented as smart glasses (e.g., a device in which one or more lenses or other transparent elements, mounted in a frame such as an eyeglass frame or sunglass frame, may be provided through which a user can directly view their physical environment and on which display content can be displayed so as to appear in combination with (e.g., overlaid on and/or integrated with) the user’s direct view of the physical environment through the lenses or other transparent elements. For example, in one implementation, the audio device may be provided as a pair of smart glasses having one or more speakers 152 and one or more microphones 206, and in which lenses, mounted in a frame having arms, are provided as transparent displays, or can be arranged such that display content (e.g., virtual content) can be displayed and/or projected thereon.

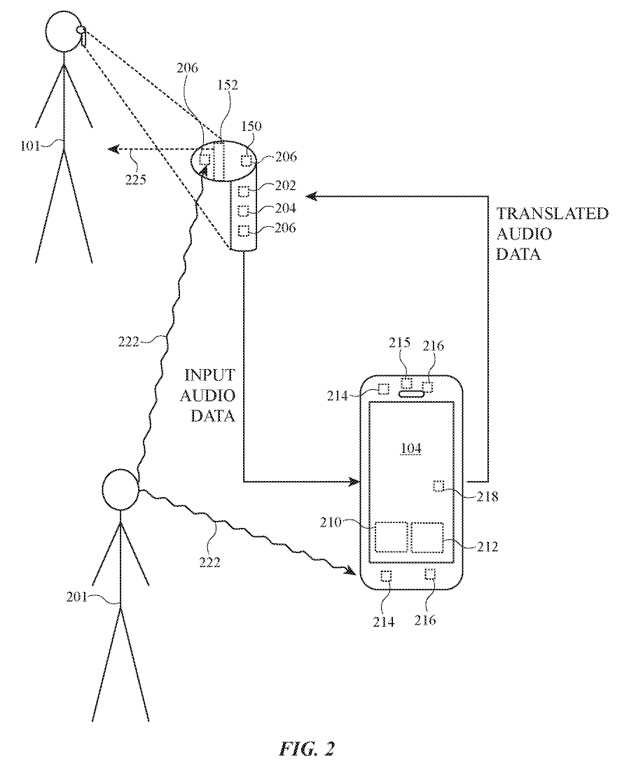

Although not visible in FIG. 1 (see, e.g., FIG. 2), each audio device may include processing circuitry (e.g., including memory and/or one or more processors) and communications circuitry (e.g., one or more antennas, etc.) for receiving and/or processing audio content and/or control signals from one or of the electronic device 104, the electronic device 110, the electronic device 115, and/or the server 120, and/or for providing audio data and/or other signals to the electronic device 104, the electronic device 110, the electronic device 115, and/or the server 120. The processing circuitry of the audio device 150 may operate the speaker 152 to generate the sound. The memory may store one or more machine learning models and/or one or more rules-based processes for performing one or more operations described herein.

The audio device 150 may include communications circuitry for communications (e.g., directly or via network 106) with the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The electronic device 104 , the electronic device 110, an electronic device 115, and/or the server 120 may include communications circuitry for communications (e.g., directly or via network 106) with audio device 150 and/or with the others of the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios.

In one or more implementations, the audio device 150 may also include one or more machine learning models that are trained to recognize the voice of user 101, any of various verbal commands from the voice of user 101, and/or any of various standardized sounds such as police or ambulance sirens, smoke or fire alarms, and/or travel announcements (e.g. station announcements, or bus stop announcements).

The audio device 150 may be communicatively coupled to a companion device, such as the electronic device 104, the electronic device 110, and/or the electronic device 115. Such a companion device may, in general, include more computing resources and/or available power in comparison with the audio device 150. In one or more implementations, memory of the electronic device 104, the electronic device 110, and/or the electronic device 115 may store code and/or instructions for one or more applications, such as a translation application. In one or more implementations, memory of the electronic device 104, the electronic device 110, and/or the electronic device 115 may store one or more machine learning models trained to perform one or more portions of the translation operations described herein. The electronic device 104, the electronic device 110, and/or the electronic device 115 may also include one or more machine learning models that are trained to recognize the voice of user 101, any of various verbal commands from the voice of user 101, and/or any of various standardized sounds such as police or ambulance sirens, smoke or fire alarms, travel announcements (e.g. station announcements, or bus stop announcements), based on audio data received from the audio device 150.

The audio device 150 may operate in various modes. For instance, the audio device 150 can operate in a first mode of operation (e.g., a transparent mode of operation), in which environmental sounds are passed, by the speaker(s) of the audio device 150, through to the ear(s) of the user 101. In this first mode of operation, audio content, such as translated audio and/or media content (e.g., received from electronic device 104) may be output by the speaker 152 of the audio device 150 without noise-cancelling content and to allow and/or enhance external sounds for pass-through to the user while the audio content plays. The audio device 150 may operate in a second mode of operation (e.g., a noise-cancelling mode of operation, such as an active noise cancellation (ANC) operation, which may be an adaptive ANC operation that uses an error signal from an error microphone to adaptively cancel residual environmental noise) in which environmental sounds received by one or more microphones of the audio device 150 are cancelled or suppressed, to prevent the environmental sounds from reaching the ear of the user 101. In this second mode of operation, audio content (e.g., translated audio content and/or media content, such as music, podcasts, audio associated with an application, a game, a video, etc.) may be played combined with noise cancellation content by the audio device (e.g., noise cancelling content that is generated, based on environmental sounds received by one or more microphones of the audio device 150 to destructively interfere with, and thereby cancel, the environmental sounds).

Audio device 150 may also include one or more sensors such as touch sensors and/or force sensors for receiving user input. For example, a user/wearer of audio device 150 may tap a touch sensor or pinch the force sensor briefly to control the audio content being played, to control volume of the playback, to start or end a translation session, and/or to toggle between the transparent and noise-cancelling modes of operation. In one or more implementations, the user may hold down the force sensor while the audio device is operated in the noise-cancelling mode of operation to temporarily switch to the transparent mode of operation until the force sensor is released. In one or more implementations, the user 101 may provide an input to the sensor(s) 151 to enable or disable a translation operation at the audio device 150 and/or at a companion device, such as the electronic device 104, the electronic device 110, and/or the electronic device 115.

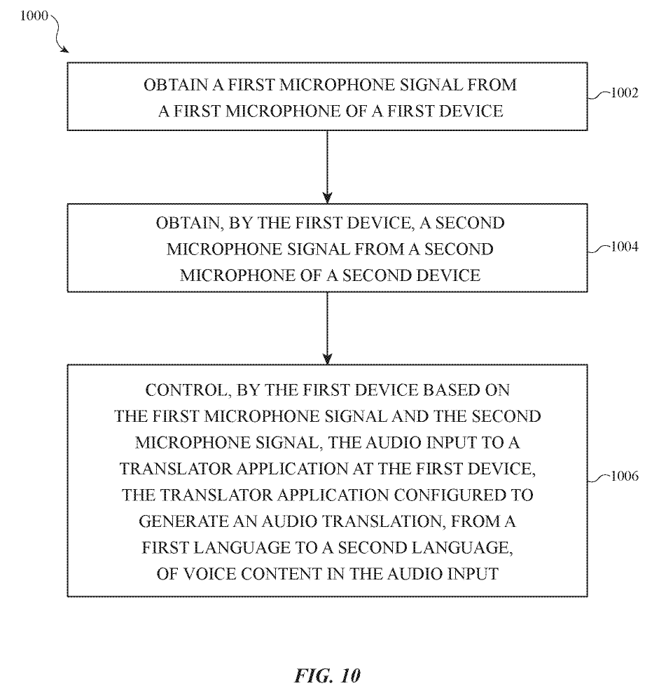

The electronic device 104 may be, for example, a portable computing device, such as a smartphone, a laptop computer, a peripheral device (e.g., a digital camera, headphones), a tablet device, a wearable device such as a smart watch, a smart band, and the like, any other appropriate device that includes, for example, processing circuitry and/or communications circuitry for providing audio content to audio device(s) 150. In FIG. 1, by way of example, the electronic device 104 is depicted as a mobile smartphone device with a touchscreen. In one or more implementations, the electronic device 104 and/or the audio device 150 may be, and/or may include all or part of, the electronic device discussed below with respect to the electronic system discussed below with respect to FIG. 11.

The electronic device 110 may be, for example, a portable computing device, such as a smartphone, a tablet device, a laptop computer, a peripheral device (e.g., a digital camera, headphones), a tablet device, a wearable device such as a smart watch, a smart band, and the like, any other appropriate device that includes, for example, processing circuitry and/or communications circuitry for providing audio content to audio device(s) 150. In FIG. 1, by way of example, the electronic device 110 is depicted as a tablet device with a touchscreen. In one or more implementations, the electronic device 104 and/or the audio device 150 may be, and/or may include all or part of, the electronic device discussed below with respect to the electronic system discussed below with respect to FIG. 11.

The electronic device 115 may be, for example, desktop computer, a portable computing device such as a laptop computer, a smartphone, a peripheral device (e.g., a digital camera, headphones), a tablet device, a home hub device, or a wearable device such as a watch, a band, and the like. In FIG. 1, by way of example, the electronic device 115 is depicted as a desktop computer. However, this is merely illustrative. In some implementations, the electronic device 115 may be implemented as a home-control device (e.g., a hub device or other device) that is communicatively coupled to one or more network-connected devices in a home or building, and that is configured to generate control signals for operating the one or more network-connected devices. The electronic device 115 may be, and/or may include all or part of, the electronic system discussed below with respect to FIG. 11.

In one or more implementations, two or more of the devices of FIG. 1 may be owned by and/or registered to an account of the same user. For example, the audio device 150 and the electronic device 104 (e.g., and/or the electronic device 110 and/or the electronic device 115) may be owned by, registered to (e.g., with the server 120), and/or logged into an account of the user 101.

The server 120 may form all or part of a network of computers or a group of servers 130, such as in a cloud computing or data center implementation. For example, the server 120 stores data and software, and includes specific hardware (e.g., processors, graphics processors and other specialized or custom processors, such as for user authentication and/or authorization, account services, and/or streaming media content to the electronic device 104, the electronic device 110, and/or the electronic device 115. In an implementation, the server 120 may function as a cloud storage server. In one or more implementations, the server 120 may store machine-learning models trained to translate audio data including speech in one or more first languages (e.g., English, French, Spanish, Dutch, German, Swedish, Hindi, one or more Chinese languages, or the like) into audio data including computer-generated speech in one or more second languages (e.g., one or more others of English, French, Spanish, Dutch, German, Swedish, Hindi, one or more Chinese languages, or the like). Translation models may be configured to translate one language into one other language, multiple different languages into one language, or multiple different languages into multiple other different languages. In one or more implementations, the audio device 150, the electronic device 104, the electronic device 110, and/or the electronic device 115 may obtain one or more of the translation models for execution at the audio device 150, the electronic device 104, the electronic device 110, and/or the electronic device 115. For example, the user 101 may select from one or more target translation languages using a user interface of a translation application at the audio device 150, the electronic device 104, the electronic device 110, and/or the electronic device 115, which may cause that device to download the corresponding translation model(s) in those one or more selected target translation applications. For example, an English-to-French translation model may be downloaded to the audio device 150, the electronic device 104, the electronic device 110, and/or the electronic device 115 prior to or during travel of an English-speaking person to France or another francophone country.

FIG. 2 illustrates an example use case in which the electronic device 104 operates as a companion device to the audio device 150 of the user 101 during a translation operation, in accordance with aspects of the subject disclosure. As shown in FIG. 2, the audio device 150 may include processing circuitry 202, a speaker 152, one or more sensors 204, and/or one or more microphones 206. For example, the sensors 204 and the microphones 206 may be implementations of the sensors 151 of FIG. 1. As shown, the audio device 150 may include multiple microphones 206. The multiple microphones 206 may include a microphone 206 positioned (e.g., behind the speaker 152) to receive environmental sounds, a microphone 206 positioned (e.g., nearest to the wearer’s mouth) to receive voice input from the wearer, and/or a microphone 206 positioned (e.g., in front of the speaker 152) as an error microphone for detecting sounds (e.g., residual, or uncancelled environmental sounds) in or near the ear canal of the wearer. The sensor(s) 204 may include inertial measurement unit (IMU) sensors (e.g., accelerometers, magnetometers, and/or gyroscopes), proximity sensors, touch sensors, force sensors, and/or other sensors. In the example, of FIG. 2, the audio device 150 is implemented as an earbud, and may be one of a pair of earbuds having the same or similar components and configured for wired or wireless communication between the earbuds of the pair.

The electronic device 104 may include processing circuitry 210, memory 212, communications circuitry 215, one or more speakers 216, one or more microphones 214, and/or one or more sensors 218. As shown, the electronic device 104 may include multiple microphones 214 at various locations. The sensor(s) 218 may include a light sensor, inertial measurement unit (IMU) sensors (e.g., accelerometers, magnetometers, and/or gyroscopes), proximity sensors, touch sensors, force sensors, and/or other sensors.

In the example of FIG. 2, the user 101 may be attempting to have a conversation with a person 201, other than the user 101. In one example use case, the user 101 may be able to speak and understand one language, such as English, and the person 201 may be able to speak and understand a different language, such as Spanish. The user 101 may not be able to speak or understand (e.g., or may have only a limited ability to speak and understand) the other language of the person 201. In order, for example, to facilitate such a conversation, the electronic device 104 may perform a translation operation that translates speech (e.g., including words, phrases, sentences, etc.) from the person 201 in the second language (e.g., Spanish) into an audio output that includes a computer generated translation, in the first language (e.g., English), of the speech of the person 201 in the second language.

For example, a voice 222 of the person 201 may be received by one or more of the microphones 206 of the audio device 150 and or by one or more microphones 214 of the electronic device 104. Input audio data, such as a microphone signal that includes a representation of the voice 222 of the person 201, may be transmitted from the audio device 150 to the electronic device 104 (e.g., a companion device). A translation application running at the electronic device 104 may generate, responsive to receiving the input audio data from the audio device 150 and/or microphone signals from the microphones 214 of the electronic device 104, translated audio data. As shown, the translated audio data may be transmitted from the electronic device 104 to the audio device 150. The speaker 152 of the audio device 150 may then generate an audio output 225, corresponding to the translated audio data, that includes a computer-generated translation of the voice 222 of the person 201. In this way, the electronic device 104 and the audio device 150 may allow the user 101 to understand the speech of the person 201 in substantially in real time as the person 201 speaks (e.g., with a delay of one or two seconds or less than one second), even if the person 201 is speaking in a language that the user 101 does not understand.

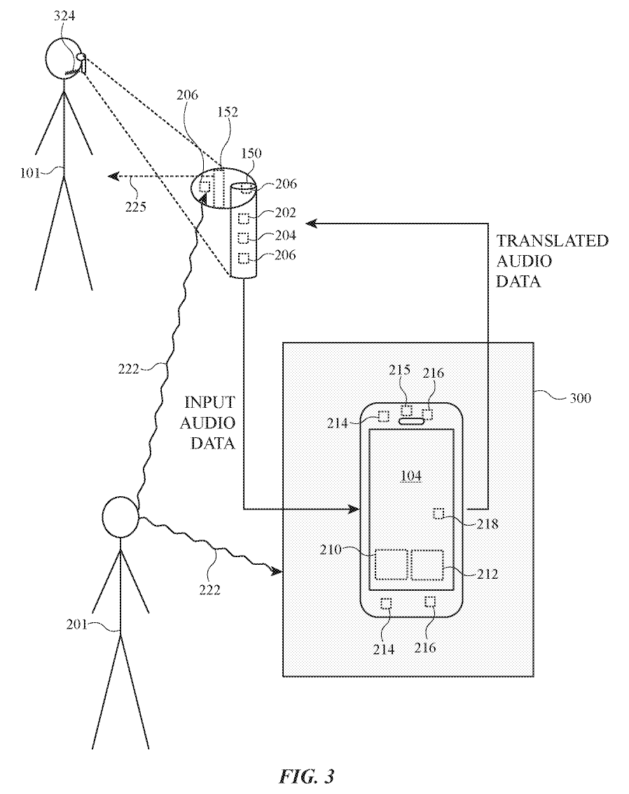

In the example of FIG. 2, for simplicity of the initial discussion, the only sound depicted as being received by the microphones 206 of the audio device 150 and the microphones 214 of the electronic device 104 is the voice of the person 201. In this example, the microphones 206 of the audio device 150 and the microphones 214 of the electronic device 104 both receive the voice 222 of the person 201. However, as illustrated in FIG. 3, a translation operation using the electronic device 104 and the audio device 150 may not always occur in conditions in which the voice 222 of the person 201 is the only sound received at the microphones or in which the microphones of both devices receive the voice 222.

For example, at some times during which the person 201 is speaking with their voice 222, the user 101 may also speak (e.g., overlapping speech can occur). In such a use case, a voice 324 of the user 101 may also be received at the microphones 206 of the audio device 150 (e.g., overlapping or partially overlapping with the voice 222 of the person 201). The voice 324 may also be received at one or more of the microphones 214 of the electronic device 104.

FIG. 3 also illustrates how, in some use cases, an obstruction 300 (e.g., a container or other object) may block, or suppress, the voice 222 of the person 201 from reaching the microphones 214 of the electronic device 104. For example, the electronic device 104 may be, at one or more times, located in a container, such as a pocket, a bag, a purse, a backpack or other container. In these example use cases, the microphones 214 of the electronic device 104 may be physically blocked from receiving some or all of the voice 222 of the person 201.

Because, as illustrated in FIG. 3 for example, the voice 222 of the person 201 can be received in combination with other sounds (e.g., including the voice 324 of the user 101), and/or the microphones to 214 of the electronic device 104 can be blocked or obstructed to varying degrees, it can be beneficial to be able to variably and/or dynamically control which microphones provide audio inputs to the translation application at the electronic device 104 (e.g., based on the conditions in the physical environment around the electronic device 104 and the audio device 150). Aspects of the subject technology can provide dynamic control of the input to a translation application in a way that adaptively responds to changing states of the electronic device 104 and/or changing states of the sound environment around the audio device 150 and or the electronic device 104.

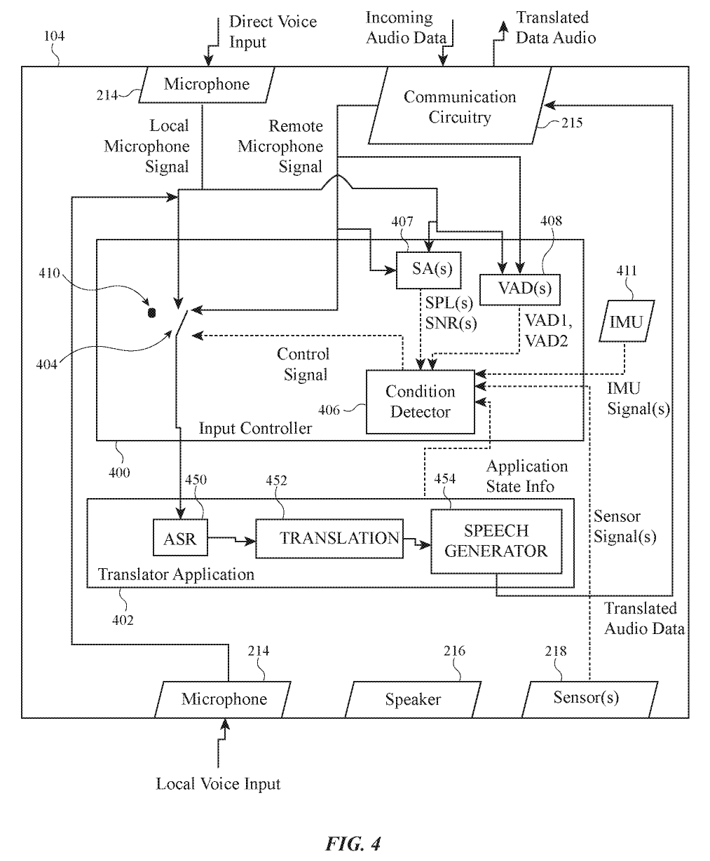

For example, FIG. 4 is a block diagram of the electronic device 104, illustrating various operations that may be performed by the electronic device 104 during a translation operation. Various portions of the architecture of FIG. 4 can be implemented in software, firmware, and/or hardware, including by one or more processors and a memory device containing instructions, which when executed by the processor cause the processor to perform the operations described herein. For example, in FIG. 4, the trapezoidal boxes may indicate that the microphones 214, the speaker 216, the sensor(s) 218, the communication circuitry 215, and the IMU 411 may be hardware components, and the rectangular boxes may indicate that one or more signal analyzers (SAs) 407, one or more voice activity detectors (VADs) 408, a condition detector 406, an input controller 400, and a translator application 402 may be implemented in software, including by execution of instructions by one or more processors (e.g., processing circuitry 210 of FIG. 2) and a memory device (e.g., memory 212) containing the instructions, which when executed by the processor cause the processor to perform the operations described herein.

As shown in FIG. 4, one or more microphones 214 of the electronic device 104 may receive a direct voice input, such as the voice 222 of the person 201 of FIGS. 2 and 3. As shown, communication circuitry 215 of the electronic device may also receive incoming audio data, such as the input audio data from the audio device 150 as shown in FIGS. 2 and 3. For example, the input audio data may be an encoded microphone signal from one or more microphones 206 of the audio device 150. The direct voice input may include the voice 222 of the person 201 when the person 201 is speaking, and may also include the voice 324 of the user 101 when the person 201 is speaking. The incoming audio data from the audio device 150 may include may also include the voice 222 of the person 201 when the person 201 is speaking, and may also (e.g., primarily, in use cases in which the audio device 150 is being worn by the user 101) include the voice 324 of the user 101 when the user 101 is speaking.

As shown, the electronic device 104 may include an input controller 400 that controls an input to a translator application 402. In the example of FIG. 4, the input controller 400 is depicted as being separate from the translator application 402. In one or more other implementations, some or all of the functionality of the input controller 400 as described herein can be performed by the translator application (e.g., to internally control the input to a translation block 452 of the translator application). The input controller 400 may dynamically control the input to the translator application on a continuous basis during a translation operation, periodically, and/or responsive to one or more decision-point triggers. As examples, decision point triggers may include the start of a translation session, a change in a state of the translator application 402, a change in the quality and/or content of microphone signals from various microphones, and/or a change in a state of the electronic device 104.

In one or more implementations, the translator application 402 may include one or more machine learning models and or one or more rules-based processes that are trained and/or programmed to (i) receive an audio input including voice content in a first language and (ii) generate a corresponding audio output that includes a computer-generated version of the voice content translated into a second language different from the first language. For example, the translator application 402 may include an automatic speech recognizer (ASR) 450 that converts speech represented in a microphone signal to text, a translation block 452 that translates text in the first language to translated text in the second language, and a speech generator 454 that generates an audio signal (e.g., translated audio data) based on the translated text in the second language. However, this example of the functionality of the translator application is merely illustrative, and in other implementations, the translator application may generate the translated audio data differently (e.g., using a machine learning model that has been trained to generate translated audio data directly from input audio data without first converting the input audio data to text). In various implementations, the translation block 452 may be configured (e.g., trained) to perform a direct translation of words and/or phrases into the second language, or may include a large language model (e.g., on device, or off-device with explicit permission of the people whose voice(s) are to be translated) that translates the meaning of the speech in the first language into corresponding words in the second language. As shown, the translated audio data generated by the translator application 402 may be provided to the communication circuitry 215 for (e.g., encoding and) transmission to the audio device 150. For example, when (e.g., decoded and) provided to the speaker 152 of the audio device 150, the translated audio data may cause the speaker 152 to generate sound that mimics a voice of a person speaking the translated text.

As shown in FIG. 4, the input controller 400 may include a switch 404 (e.g., a digital switch or software switch). The switch 404 may be controlled by a control signal generated by a condition detector 406 of the input controller 400. As indicated in the figure, the control signal may control the switch 404 to selectively provide, to the translator application 402 (e.g., to a translation block 452 of the translator application) one of: a local microphone signal from the microphone(s) 214 of the electronic device 104, a remote microphone signal derived from the incoming audio data from the audio device 150, or a null input 410 to the translator application.

As shown, the condition detector 406 may receive various input signals that can be used, by the condition detector 406, for controlling the switch 404 (e.g., for selecting the input to the translator application 402). As shown, the input signals to the condition detector 406 may include signal analysis information (e.g., one or more noise levels (sound pressure levels, or SPLs) and/or one or more signal-to-noise ratios (SNRs) of one or more of the local microphone signals and/or the remote microphone signals) from the signal analyzer(s) 407, one or more voice activity detection signals (e.g., VAD1, VAD2) from the VAD(s) 408, one or more sensor signals from the sensor(s) 218, one or more IMU signals (e.g., orientation and/or motion signals) from the IMU 411, and/or application state information from the translator application.

In one or more implementations, the condition detector 406 may determine device state information for the electronic device 104 based on sensor signal(s) from the sensor(s) 218 and/or the IMU signals from the IMU 411. In one or more other implementations, device state information may be determined by a separate process at the electronic device 104 and provided to the condition detector 406.

For example, the condition detector 406 may determine whether the electronic device 104 (e.g., and/or one or more microphones 214 thereof) is in an obstructed condition (e.g., in a pocket or a bag that may obstruct one or more of the microphones 214) or an unobstructed condition (e.g., in the hand of the user 101 or the person 201, or on a table or surface near or between the user 101 and the person 201) using the sensor signals and/or the IMU signals. For example, the sensor(s) 218 may include one or more proximity sensors. Proximity sensor signals may be used to determine whether an object (e.g., the interior of a container, such as a pocket or a bag) is touching or in close proximity to (e.g., within a centimeter of) of the electronic device 104, thereby indicating the electronic device 104 is in an obstructed state. In one or more implementations, the condition detector 406 may use other information to determine and/or confirm the obstructed/unobstructed condition of the electronic device 104. For example, the electronic device 104 may perform one or more acoustic tests that compare the microphone signals of multiple microphones 214 (e.g., responsive to predetermined outputs of one or more speakers 216) to determine whether one or more of the microphones 214 of the electronic device are occluded or obstructed. As another example, if the IMU signals indicate that the electronic device 104 is face-down, the condition detector 406 may determine that the electronic device 104 is unobstructed (e.g., laying face down on a table or surface), even if the proximity sensor signals indicate that the face of the electronic device is in close proximity to an object (e.g., the table or surface). As another example, if the IMU signals indicate that the electronic device 104 is moving in a characteristic motion of the hand of the user 101 (e.g., a walking motion or a conversational hand motion), the condition detector 406 may determine that the electronic device 104 is unobstructed (e.g., being held by the user 101 or the person 201), even if the proximity sensor signals indicate that an object (e.g., a hand) is in close proximity one or more portions of the electronic device 104 (e.g., due to a user’s hand or finger covering the proximity sensor while leaving the microphone(s) 214 unobstructed).

In one or more implementations, the condition detector 406 may use other input signals to determine and/or confirm whether the electronic device 104 is in an obstructed condition or an unobstructed condition. For example, the application state information received from the translator application may indicate a state of a user interface of the translator application. For example, the application state information may indicate that a user interface of the translator application is active and/or displayed in the foreground of a display of the electronic device 104, thereby indicating that the electronic device 104 is in an unobstructed state (e.g., in combination with the other signals described above indicating that the device is in the unobstructed state, and/or even if one or more of the other signals indicate that the device may be in an obstructed state). In a use case in which the application state information indicates that the user interface of the translator application is minimized, locked, or backgrounded, the user interface state information may contribute to indicating or confirming other input signals that indicate that the electronic device 104 is in an obstructed state. As another example, the condition detector 406 may receive an indication that the electronic device 104 is unlocked, thereby contributing to an indication or confirmation that the electronic device 104 is in an unobstructed state (e.g., in combination with the other signals described above indicating that the device is in the unobstructed state, and/or even if one or more of the other signals indicate that the device may be in an obstructed state).

In some examples, when the condition detector 406 determines that the electronic device 104 is in an unobstructed state, the condition detector 406 may control the switch 404 to provide the local microphone signal from the microphone(s) 214 of the electronic device 104 to the translator application 402. In some examples, when the condition detector 406 determines that the electronic device 104 is in an obstructed state, the condition detector 406 may control the switch 404 to provide the remote microphone signal from the audio device 150 to the translator application 402. However, these decisions by the condition detector 406 may also depend on other input signals received by the condition detector (e.g., in addition to the device state), such as one or more VAD signals received from the VAD(s) 408.

For example, the VAD signals may indicate when one or more voices (e.g., the voice 222 of the person 201 and/or the voice 324 of the user 101) are active (e.g., present in the local microphone signal and/or the incoming audio data). For example, the VAD(s) 408 may receive both the local microphone signal and the remote microphone signal, and may determine, from the local microphone signal and/or the remote microphone signal, whether one or more voices are present. For example, the VAD(s) 408 may include an own voice activity detector (OVAD) and a target voice activity detector (TVAD). The OVAD may be configured to detect the voice 324 of the user 101. The TVAD may be configured to detect the voice 222 of the person 201 other than the user 101. As examples, the OVAD may be trained on the user’s own voice, trained based on speech in the user’s own language, and/or configured to detect the user’s own voice based on a (e.g., approximately) known location of the user’s mouth relative to the audio device 150 (e.g., based on near-field characteristics of the user’s voice in close proximity to the microphones 206 of the audio device 150, such as different arrival times of the voice 324 at different microphones of the audio device 150). As examples, the TVAD may be trained to detect speech in another language and/or to detect a speaker other than the user based on location information for a target speaker other than the user (e.g., responsive to detection of far-field characteristics of a person’s voice in the microphone signals from the microphones 206 of the audio device 150 and/or the microphones 214 of the electronic device 104, such as a common, or same, arrival time of the voice 222 at the microphones of the audio device 150).

In one or more implementations, the OVAD of the VAD(s) 408 may generate a first VAD signal (e.g., VAD1) that indicates whether the user’s own voice is present in the local microphone signal and/or the remote microphone signal, and the TVAD of the VAD(s) 408 may generate a second VAD signal (e.g., VAD2) that indicates whether the voice of a target person (e.g., person 201) is present in the local microphone signal and/or the remote microphone signal. In one or more implementations, the first VAD signal and the second VAD signal may each include a binary value indicating speech vs. non-speech of the corresponding user/person. Using the first VAD signal from the OVAD and the second VAD signal from the TVAD , the electronic device 104 can automatically switch between translating the voice of the target person and (i) pausing translation during the user’s own speech and/or (ii) translating the user’s own speech.

In the example of FIG. 4, the VADs 408 operate at the electronic device 104 to detect the user’s own voice and the target voice in the local microphone signal and/or the remote microphone signal. In one or more other implementations, one or more of the VADs 408 (e.g., an OVAD and/or a TVAD) may operate on the remote microphone signal at the audio device 150 before the remote microphone signal is provided from the audio device 150 to the electronic device 104. In one or more implementations, the remote microphone signal may include a single stream that the VADs 408 (at the electronic device 104 or at the audio device 150) may label time windows or time intervals of as including own voice only (e.g., OVAD =1 and TVAD !=1), target voice only (TVAD =1 and OVAD !=1), no voice detection (e.g., OVAD =0 and TVAD =0), or both own voice and target voice (e.g., OVAD =1 and TVAD =1).

In one or more other implementations, the remote microphone signal may be a multi-stream signal that includes multiple streams, such as an own voice stream and a target voice stream, some or all of each of which can be provided to the translator application 452. For example, the audio device 150 may include an OVAD that detects the user’s own voice in the microphone signal(s) from the microphone(s) 206 of the audio device 150, and a TVAD that detects the target person’s voice in the microphone signal(s) from the microphone(s) 206 of the audio device 150. The audio device 150 may generate, based on the outputs of the OVAD and the TVAD, a first audio stream (e.g., an own voice stream) that emphasizes the user’s own voice in the microphone signals from the microphone(s) 206 of the audio device 150 (e.g., by capturing the microphone signals using a beamforming operation that targets an expected location of a mouth of the user, and/or by cancelling ambient noise and/or the target person’s voice in the first audio stream) and a second audio stream (e.g., a target voice stream) that emphasizes the target person’s voice in the microphone signals from the microphone(s) 206 of the audio device 150 (e.g., by capturing the microphone signals using a beamforming operation that targets an expected and/or detected location of the target person, and/or by cancelling ambient noise and/or the user’s own voice in the first audio stream). The first audio stream and the second audio stream can then be provided from the audio device 150 to the electronic device 104 (e.g., concurrently, as a multi-stream signal) as the remote microphone signals. Providing multi-stream audio in this way can facilitate continuing to provide a translation of the target person’s speech even while the user is speaking (e.g., in contrast with pausing translation, such as by providing a null input to the translator application, when both the target person and the user are speaking).

In one or more implementations, the own voice stream may be included in the remote microphone signals only when the user’s own voice is detected (e.g., using an OVAD at the audio device 150). In one or more other implementations, the own voice stream may be provided (e.g., and configured, such as using user-targeted beamforming and/or ambient noise cancellation, designed for enhancement of the voice of the user) whether or not the voice of the user is present in the own voice stream. For example, buffered time windows or time intervals of the own voice stream may be labeled as including or not including the user’s own voice when buffers with or without, respectively, the user’s own voice are included in the own voice stream. In one or more implementations, the target voice stream may be included in the remote microphone signals only when the target person’s voice is detected (e.g., using a TVAD at the audio device b). In one or more other implementations, the target voice stream may be provided (e.g., and configured, such as using remote-targeted beamforming and/or ambient noise cancellation, to enhance the voice of the target person) whether or not the voice of the target person is present in the target voice stream. For example, buffered time windows or time intervals of the target voice stream may be labeled as including or not including the target person’s voice when buffers with or without, respectively, the target person’s voice are included in the target voice stream.

In one or more implementations, the remote microphone signals may be provided with, or may include, metadata for the one or multiple audio streams included therein. As examples, the metadata may include OVAD and/or TVAD labels for time windows and/or time intervals of the one or multiple audio streams included therein, and/or may include spatial information, such as direction of arrival (DOA) information (e.g., as determined based on multiple microphone signals from multiple microphones 206 of the audio device 150) for the time windows and/or time intervals of the one or multiple audio streams included therein.

In one or more implementations, the spatial information may be used by the electronic device 104 (e.g., by the speech generator 454 and/or a subsequent spatializer) to generate spatialized translated audio data to be provided to the audio device 150. For example, the spatialized audio output, when output by the speakers 152 of the audio device 150, may be perceived, by the user 101, as coming from (e.g., emanating from or being emitted from) the same spatial location (e.g., direction) as the target person (e.g., person 201). In some implementations, the spatialization of the audio output may account for movements of the user’s head and/or the audio device 150 during a delay time between the target speech 324 occurring the physical environment and the output of the spatialized translation of that speech from a speaker of a device (e.g., by tracking the position and/or motion of the user’s head, and modifying the spatialization to remove the detected head motion, so that the perceived location of the spatialized audio output remains static independent of any movement of the user’s head). In one or more implementations, the spatialized audio data may be voice-matched to a voice of the person 201. For example, the metadata for the one or multiple audio streams may include voice characteristic information (e.g., a tone, timbre, prosody, rhythm, tempo, or the like) determined by the audio device 150 for the target person, and the speech generation may generate the spatialized audio output with the same or similar voice characteristics. This spatialization and/or voice matching can be helpful to the user for perceiving their environment naturally during a translation session when, for example, multiple people are speaking around the user, when the user’s head is moving, and/or when the target person is moving relative to the user.

In one or more implementations, the audio device 150 and/or the electronic device 104 may use respective determined locations of one or more respective people speaking in the physical environment around the user 101 (e.g., where the respective locations are determined using DOA information obtained based on differences between multiple microphone signals from multiple microphones, and/or based on other signals, such as images of the one or more people) to filter out and/or otherwise suppress ambient speech around the user 101 from the local microphone signal and/or the remote microphone signal (e.g., so as to enhance the speech of one or more target speakers). For example, the user 101 may be having a conversation with the person 201 in a physical environment in which people other than the user 101 and the person 201 are also talking (e.g., other people talking into their phones or with yet other people in the physical environment). As another example, the user 101 may be listening to a conversation between two (or more than two) other people with or without actively participating in the conversation (e.g., including during periods in which the user is simply not speaking temporarily, or in which the other two (or more than two) people are speaking in another language and may not understand the user speaking in their own language). In these example use cases, it may be beneficial to be able to enhance the speech of speakers within a dynamically adjustable “field-of-view” (FOV) of a microphone array, and to filter out, or otherwise suppress the voices of people outside that dynamic field-of-view. For example, in the use case in which the user 101 is having a conversation with the person 201 in a physical environment in which people other than the user 101 and the person 201 are also talking, the audio device 150 and/or the electronic device 104 may dynamically adjust a beam generated by co-operation of multiple microphones of the audio device 150 and/or the electronic device 104 to move with movement of the person 201 relative to the user 101 (e.g., due to the user 101 moving or turning their head and/or due to motion of the person 201 themselves), and/or to expand or contract and/or change shape to exclude the voices of the people other than the person 201. In some examples, the person 201 may be identified as the target person based on a higher signal-to-noise ratio of the voice of the person 201 relative to the voices of the other people, and/or based on other signals, such as the user’s head being oriented toward the person 201 (e.g., as determined using image sensors and/or motion/orientation sensors of the audio device 150 and/or the electronic device 104), the user being engaged with the person 201 (e.g., speaking towards, looking at, and/or facing the person 201), the depth or distance of the person 201 from the user, or the like. As another example, in the use case in which the user 101 may be listening to a conversation between two (or more than two) other people, the beam (e.g., a FOV of the beam) may be expanded in size and/or shape relative to the beam used when the user 101 is talking to a single other person (e.g., to enhance the voices of the two (or more than two) people to which the user is listening), and may expand or contract (and/or change shape) as the two (or more than two) people move away from each other or toward each other (e.g., or to include the location of another person that joins the conversation between the two (or more than two) other people to which the user 101 is listening). In this way, whether the voices of one, two, or more than two people to which the user 101 is listening are translated from another language into computer-generated speech in the user’s language, or when the voices are merely passed through to the ears of the user untranslated by the speaker(s) 206 of the audio device 150, the dynamic beam (e.g., a dynamic FOV of the beam, including the direction, shape, and/or size of the beam) can help to ensure that the incoming audio signals (e.g., to the user’s ears and/or to a translation application) include the voice(s) of the person or people of interest to the user.

In one or more implementations, time windows or time intervals of the local microphone signal and the remote microphone signal may each be buffered at the electronic device 104. The first VAD signal and the second VAD signal may be generated at the electronic device 104 and/or at the audio device 150 for each window or time interval. The condition detector 406 may control the input to the translator application 402 (e.g., control the switch 404) based (e.g., in part) on the first VAD signal and the second VAD signal.

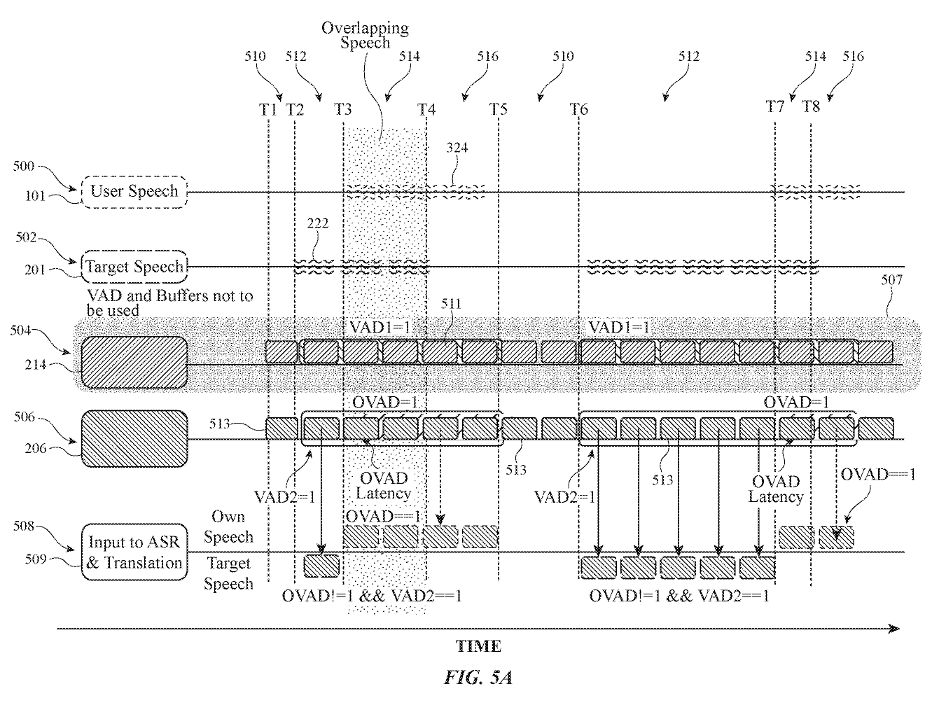

For example, FIG. 5A is a timing diagram illustrating how the input controller 400 may control the input to the translator application 402 (e.g., control the switch 404) based (e.g., in part) on the first VAD signal and the second VAD signal. In this example, the first VAD signal and the second VAD signals are generated locally at the electronic device 104. For example, FIG. 5A shows a timeline 500 of the voice 324 of the user 101, a timeline 502 of the voice 222 of the person 201, a timeline 504 of the local microphone signal of the microphone 214 of the electronic device 104, a timeline 506 of the remote microphone signal of the microphone 206 of the audio device 150, and a timeline 508 of an input buffer 509 from which the translator application can read input audio data for translation.

In the example of FIG. 5A, box 507 indicates that the microphone 214 of the electronic device 104 is blocked (e.g., the electronic device 104 has been determined, such as by the condition detector 406, to be in an obstructed condition or obstructed state). For this reason, none of the buffers 511 of local audio data from the microphone 214 are provided to the input buffer 509 of the translator application in the example of FIG. 5A. Instead, buffers 513 of the remote audio data from the microphone(s) 206 (e.g., of the audio device 150) are provided to the input buffer 509 of the translator application (e.g., after being passed from the audio device 150 to the electronic device 104). However, FIG. 5A also illustrates that, in the example of FIG. 5A in which a single stream from the microphone(s) 206 of the audio device 150 is provided, at some times during a translation operation, no data may be provided to the input buffer 509 of the translator application (e.g., the switch 404 of FIG. 4 is switched to the null input 410).

For example, a translation operation using the electronic device 104 and the audio device 150 may begin at a time T1. For example, the translation operation may begin at time T1 responsive to a user launching the translator application 402, starting a translation session in a system control center of the electronic device 104, pressing or otherwise interacting with a “start” option in the user interface of the translator application 402, providing a user input (e.g., a tap, a press, a press and hold, a multiple press, providing a voice input to a virtual assistant application to start a translation session, or other input predefined for initiating a translation session and/or launching the translator application 402, and/or responsive to the electronic device 104 (e.g., the VADs 408) automatically detecting speech in proximity to the electronic device 104 in a language other than a primary language of the user 101.

In the example of FIG. 5A, the timeline includes portions 510 (e.g., from time T1 to time T2 and from time T5 to T6) during which no speech is present in the remote microphone signal, portions 512 (e.g., from time T2 to time T3 and from time T6 to time T7) during which only target speech (e.g., speech from the person 201 for translation) is present in the remote microphone signal, overlapping speech portions 514 (e.g., from time T3 to time T4, and from time T7 to T8) during which both the user’s speech (e.g., speech from the user 101) and target speech (e.g., speech from the person 201 for translation) are present in the remote microphone signal, and portions 516 (e.g., from time T4 to time T5, and after time T8) during which only the user’s speech (e.g., speech from the user 101) is present in the remote microphone signal.

As shown, during the portions 512 (e.g., from time T2 to time T3 and from time T6 to time T7) during which only target speech (e.g., speech from the person 201 for translation) is present in the remote microphone signal, the remote microphone signal is provided (e.g., from buffers 513 storing the remote microphone data) to the input buffer 509 for translation. As shown in FIG. 5A, during overlapping speech portions 514 during which both the user’s speech (e.g., speech from the user 101) and target speech (e.g., speech from the person 201 for translation) are present in the remote microphone signal, no buffers containing the voice 222 of the person 201 may be provided to the input buffer 509 (e.g., by providing no audio data to the input buffer 509, such as by providing a null signal to the input buffer 509 as in the example of FIG. 4, or by providing only buffers 513 containing the user speech 324 to the input buffer 509) . In this way, translation may be paused when the user 101 is speaking at the same time as the person 201 in some implementations. In this way, the user 101 may experience less interruptive output from the audio device 150 while they are speaking, thus allowing the user 101 to have a more natural, conversation-style interaction with the person 201. As discussed in further detail hereinafter, in other implementations, the translation of the voice 222 of the person 201 can continue when the user 101 is speaking (e.g., by continuing to provide the local microphone signal or the remote microphone signal to the translator application for translation of the voice 222 of the person 201), and the audio output of the translation by the audio device 150 can instead be ducked (e.g., reduced in volume relative to other audio content) or blurred (e.g., blending or smearing the voice in time, low-pass filtering, and/or adding reverberation and/or echo) to help avoid interrupting the user 101 while they are speaking (e.g., while still allowing a reduced amount of the other person’s translated speech to pass through to the user). For example, as discussed in further detail hereinafter in connection with FIG. 5B, a multi-stream signal having an own voice stream and a target voice stream may facilitate continuing to provide the translation of the voice 222 of the person 201 during periods of overlapping speech.

FIG. 5A also illustrates how, in some implementations and/or use cases in which a single stream is provided in the remove microphone signal from the microphone(s) 206 (e.g., from the audio device 150), during times when the user’s own voice is detected (e.g., VAD1 = 1 or OVAD = 1, such as during overlapping speech portions 514 and/or portions 516), the remote microphone signal may be provided (e.g., to the input buffer 509 or a separate input buffer of) the translator application 402 (e.g., for translation of the user’s own voice from the user’s language into the language of the person 201, such as for output by the speaker(s) 216 of the electronic device 104). In this example of FIG. 5A, because a single stream is provided from the audio device 150 (e.g., microphone(s) 206), the buffers 513 are only used by the translator application to translate either the user’s own speech or the target speech, and the translation of the target speech is paused when the user’s speech is present (e.g., whether or not the buffers 513 containing the user’s own voice are translated). As discussed in further detail hereinafter, in other implementations in which multiple streams are provided from the audio device 150, the translation of the target speech can continue even when the user’s own speech is present.

For example, FIG. 5B illustrates an example in which two streams of buffers 587 and 589 are included in the remote microphone signal from the microphone(s) 206. In this example, the buffers 587 are own voice buffers generated from time windows or time intervals of an own voice stream of the remote microphone signal, and the buffers 589 are target voice buffers of a target voice stream of the remote microphone signal. In contrast with FIG. 5A, FIG. 5B shows how, when a multi-stream signal is provided from the audio device 150, the target voice buffers 589 that include a representation of the target person’s voice (e.g., when voice 222 of the person 201 is present) can be provided to the input buffer 509 for translation, even when the user speech 324 is present (e.g., even during the overlapping speech periods). As shown, the buffers 589 including the user’s own speech may optionally also be provided to the translator application for translation of the user’s own speech into the language of the person 201. In the example of FIG. 5B, the timeline 504 showing the buffers 511 from the microphones 214 of the electronic device 104 is omitted for simplicity of the figure. However, it is appreciated that the buffers 511 from the microphones 214 of the electronic device 104 can be generated in the example of FIG. 5B as they are in the example of FIG. 5A.

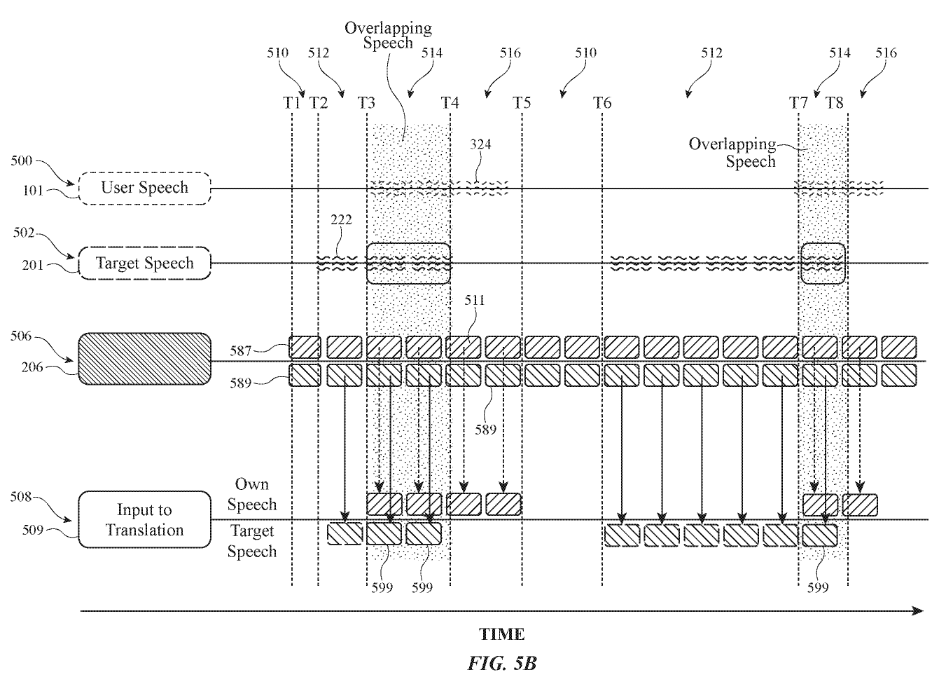

FIG. 6 is a timing diagram that illustrates an example of how the input to the translator application 402 (e.g., via the input to the input buffer(s) 509) may be controlled differently in a different use case. For example, in FIG. 6, the box 507 of FIG. 5A is removed, indicating that the electronic device 104 has been determined (e.g., by the condition detector 406) to be in an unobstructed state. As examples, the electronic device 104 may be on a table or other surface between the user 101 and the person 201, the user 101 may be holding the electronic device 104 near the person 201, or the person 201 may be holding the electronic device 104. In the example of FIG. 6, the portions 510, 512, 514, and 516 of the timeline are the same as those in FIG. 5A, and either the buffers containing the user’s own voice or the null input are provided to the input buffer 509 when the user’s own voice is detected, as in FIG. 5A. However, in FIG. 6, during the portions 512 (e.g., from time T2 to time T3 and from time T6 to time T7) during which only target speech (e.g., speech from the person 201 for translation) is present in the remote microphone signal and/or the local microphone signal, the local microphone signal is provided (e.g., by the input controller 400 as described in connection with FIG. 4) to the input buffer 509 for translation in FIG. 6 (e.g., rather than the remote microphone signal in the example of FIG. 5A). In the example of FIG. 6, the remote microphone signal (e.g., the entire remote microphone signal in a single-stream implementation, or an own-voice stream of the remote microphone signal in a multi-stream implementation) may still be provided to the input buffer 509 or the other input buffer during the portions 514 and 516 during which the user’s own voice is present in the remote microphone signal and/or the local microphone signal (e.g., for translation of the user’s own voice in the language of the person 201, such as for output by the speaker(s) 216 of the electronic device 104).

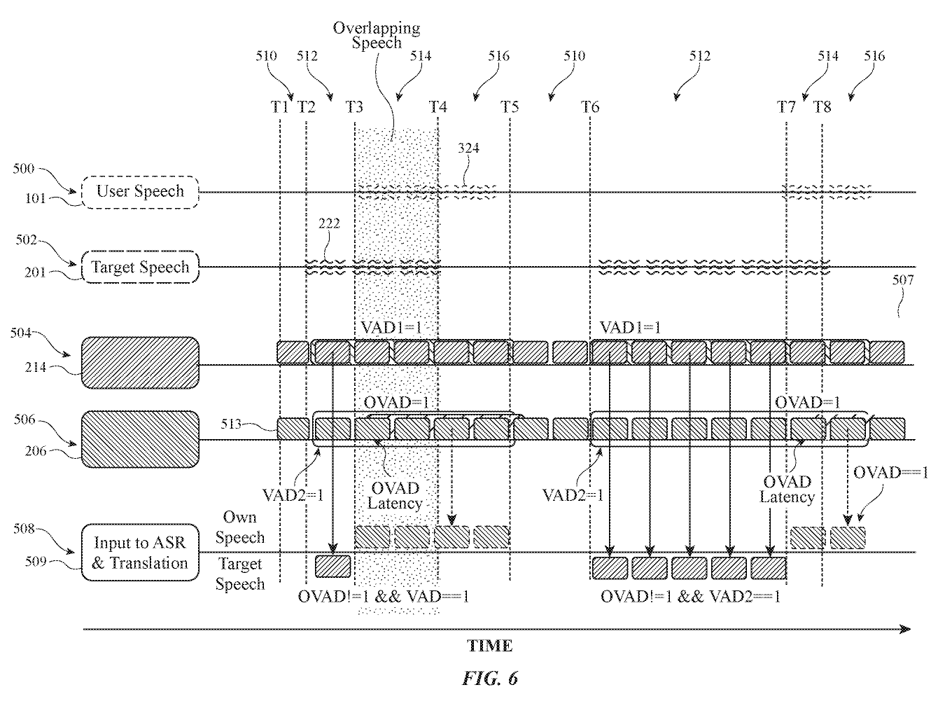

For example, FIG. 7 illustrates a block diagram of the electronic device 104 performing translation operations in a use case in which (e.g., in addition to the voice 222 of the person 201 being translated into the language of the user 101 and transmitted as translated audio data for output by the audio device 150) the user’s own voice is also translated into the language of the person 201 for output by the speaker(s) 216 of the electronic device 104. In this example use case, the speaker(s) 216 may output a computer-generated translated version of the voice of the user 101, and the speaker(s) 152 of the audio device 150 may output a computer-generated translated version of the voice of the person 201, so that the user 101 and the person 201 can have a (e.g., substantially) real-time conversation with each other, speaking in their own respective languages. However, as shown in FIG. 7, a portion of the translated user speech that is output by the speaker(s) 216 of the electronic device 104 may be received by the microphone(s) 214 of the electronic device 104. In one or more implementations, the electronic device 104 may include an echo canceller 700. For example, the echo canceller 700 may use the known translated user audio data (e.g., and the known output time of that data by the speaker(s) 216) to suppress or cancel the portion of the local microphone signal that corresponds to the translated user speech that is output by the speaker(s) 216. In the example of FIG. 7, the echo cancellation is performed before the local microphone signal is provided to the signal analyzer(s) 407, the VAD(s) 408, and the switch 404. In one or more other implementations, the echo cancellation may be performed at other states of the processing flow, such as after the VAD(s) 408 and before the signal analyzer(s) 407 and the switch 404 (e.g., so that the output of the VAD(s) 408 may be used to selectively control when echo cancellation is performed. For example, echo cancellation may be performed only during times during which output from the speaker(s) 216 overlaps with translation of the voice of the person 201 in some implementations.

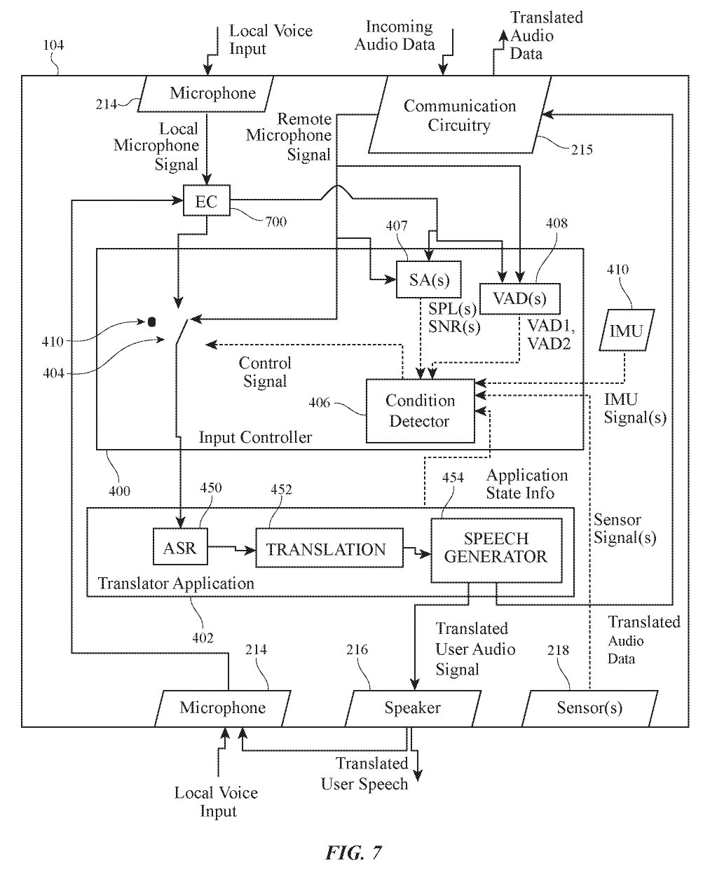

For example, FIG. 8 is a timing diagram that illustrates an example use case in which the translated user speech is output by the speaker(s) 216 of the electronic device 104. In the example of FIG. 8, a timeline 800 is included that shows the translated user speech 802 being output by the speaker(s) 216 of the electronic device 104 between the time T4 and a time T6’ that is between the time T6 and the time T7 of FIGS. 5A and 6. In the example of FIG. 8, the portions 510, 512, 514, and 516 of the timeline are the same as those in FIG. 6, and the buffers containing only the user’s speech 324 or a null input are provided to the input buffer 509 when the user’s own voice is detected, as in FIGS. 5A and 6. However, as shown, echo cancellation may be performed (e.g., by the echo canceller 700 of FIG. 7) during an echo-cancellation period 804. As shown, echo cancellation may not be performed at all times during which the speaker is operated to output the translated user speech. In the example of FIG. 8, echo cancellation is performed during an echo-cancellation period 804 during which the translated user speech that is being output by the speaker(s) 216 overlaps with the voice 222 of the person 201 being provided as input to the translator application 402 (e.g., via the input buffer 509). In this way, power and/or computing resources may be conserved by avoiding performing echo cancellation when the microphones 214 of the electronic device 104 are not providing inputs to the translator application 402.

In the example of FIG. 8, as in the examples of FIGS. 5A and 6, the remote microphone signal is a single-stream signal, and the translator application only translates the user’s own speech 324 or the voice 222 of the person 201. However, it is appreciated that the echo-cancellation operations described in connection with FIGS. 7 and 8 can also be performed in the implementation of FIG. 5B, in which the remote microphone signal is a multi-stream signal, and in which the user’s own speech 324 and the voice 222 of the person 201 are both translated during the overlapping speech periods.

In various examples described herein, the output of the translator application is a computer-generated voice speaking, in a second language, the words that the person 201 spoke in the first language, without any other content. However, in some use cases, the microphone signals may include other content. For example, the user 101 may be attending a play, an opera, or a movie in which the characters speak in a language that user does not understand, and the play, opera, or movie may include other soundtrack content, such as music or background sounds. In these use cases, the translator application and/or one or more other processes at the electronic device 104 may filter out, or otherwise suppress, the other soundtrack content, suppress or blur the other soundtrack content, or pass through the other soundtrack content unchanged (e.g. so that the user receives the full sound of the play, opera, or movie, modified solely, or primarily, by the spoken words being translated). In these use cases, the translated speech of one or more characters or performers in the play, opera, movie, etc. may be spatialized and/or voice matched, as discussed herein, to the respective locations and/or voices of speaker(s) of those characters or performers in the play, opera, movie, etc. In other examples, the speech to be translated may originate from a recording of a person’s prior speech or other (e.g., live) speech received through a loudspeaker (e.g., train or bus stop announcements, airport announcements, sporting event announcements, concert sound, or the like, while travelling).

As described herein, the electronic device 104 may selectively provide a local microphone signal, a remote microphone signal, or a null input to the translator application 402, including by providing the remote microphone signal to the translator application when the device state indicates that the electronic device is in an obstructed state. However, in some use cases, such as in a noisy environment, or when the person 201 is speaking quietly or is far from the audio device 150 and/or the electronic device 104 (e.g., resulting in a high SPL or a low SNR determination by the signal analyzer(s) 407), translation may be limited or unavailable. Accordingly, in some use cases, the electronic device 104 (e.g., the translator application 402) may provide a notification to the user 101 to move the electronic device 104 closer to the person 201 for whom translation is desired (e.g., including removing the electronic device 104 from a contain in some use cases), so that the local microphone signal can be used for the translation.

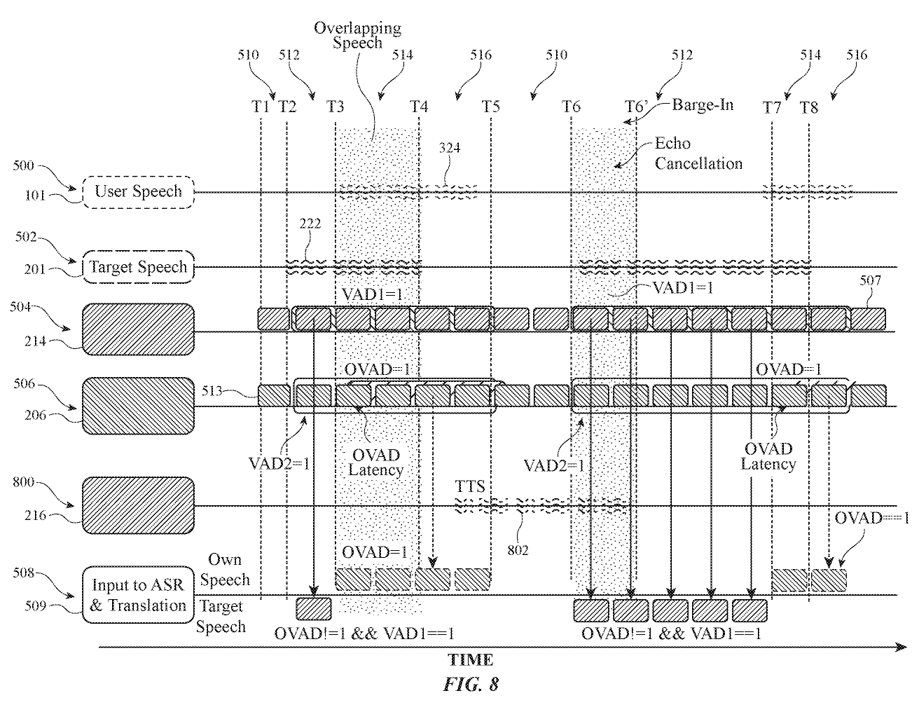

For example, FIG. 9 illustrates a notification 902 that may be provided by a user interface 900 of the translator application 402 (e.g., a notification that includes text, such as “move this device closer to the person for whom translation is desired”). In the example of FIG. 9, the notification 902 is provided by a display 904 of the electronic device 104. However, this is merely illustrative and, in various implementations, the notification may be provided by one or more other output components of the electronic device 104 and/or the audio device 150 (e.g., an audio notification, a haptic notification, or any other notification output).

Responsive to the notification 902, the user 101 may move the electronic device 104 closer to the person 201 to improve reception of the voice 222 of the person 201 for translation. In one or more other implementations, the user 101 may move another device (e.g., a smartwatch, a tablet device, one earbud of a pair of earbuds corresponding to the audio device 150, or any other device that is communicatively coupled to and/or associated with the same account as the device that is performing the translation operation) having one or more microphones closer to the person 201, and the input controller 400 may provide microphone signals from one or more microphones of that other device to the translator application 402 for translation of speech represented therein.

In various implementations, the user interface 900 may provide other functionality for a user interacting with the translator application 402. For example, the user interface 900 may include a selectable option to begin a translation session, a selectable option to select a language of the speech to be translated, and/or a language to which the speech is to be translated. As discussed herein, the translator application 402 may manage the download and/or storage of one or more translation models for one or more selected languages at the electronic device 104. In other examples, the language to be translated may be detected automatically by the electronic device 104, and the corresponding language model may be downloaded (or accessed if previously downloaded) automatically (e.g., without user input). Automatic detection of the language to be translated may include automatic detection of speech, in proximity to the user 101, in a language other than a language of the user (e.g., a user language as previously selected by the user or as automatically determined by the electronic device 104 based on the user’s own speech), and a determination of the language of the speech. Automatic detection of a language to be translated may allow conversations with multiple people in multiple languages (e.g., in a group or roundtable discussion in which multiple people speak in multiple different respective languages). In this example, the translator application 402 may translate each of the different languages detected in the speech around the user 101 into the language of the user 101 while the electronic device 104 performs the microphone switching (e.g., dynamic input control) described herein. In one or more implementations, whether multiple speakers are speaking in multiple different languages or in one common language, the audio output of the translated speech may be spatialized (e.g., by coordinated operation of multiple speakers 152 of the audio device 150, using locations and/or directions of arrival determined using multiple microphones of the audio device 150 and/or the electronic device 104) so that the translated speech of each person is perceived, by the user 101, as originating from the direction of that person. As discussed herein, this spatialization may account for any movements of the user’s head during a delay time that may occur between the speech of each person and the output of the translation of that speech (e.g., so that the speech is output at the location that the speech at the time the speech occurred).

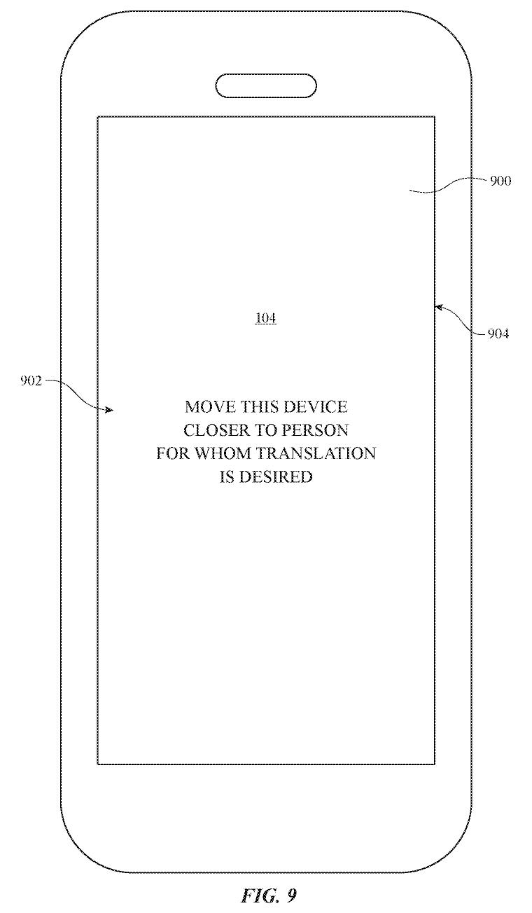

FIG. 10 is a flow chart of an example process 1000 that may be performed for microphone switching for translation in accordance with implementations of the subject technology. For explanatory purposes, the process 1000 is primarily described herein with reference to the audio device 150 and electronic device 104 described in connection with FIGS. 1-9. However, the process 1000 is not limited to the audio device 150 and electronic device 104 described in connection with FIGS. 1-9, and one or more blocks (or operations) of the process 1000 may be performed by one or more other components of other suitable devices, including the electronic device 110, the electronic device 115, and/or the servers 120. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, a first microphone signal (e.g., a local microphone signal) may be obtained (e.g., at an input controller 400) from a first microphone (e.g., microphone 214) of a first device (e.g., electronic device 104). In one or more implementations, multiple first microphone signals may be obtained from multiple first microphones at the first device.

At block 1004, the first device (e.g., the input controller 400) may obtain (e.g., over a wired or wireless connection), a second microphone signal (e.g., a remote microphone signal) from a second microphone (e.g., microphones 206) of a second device (e.g., audio device 150, which may be implemented as an earbud, a pair of earbuds, headphones, or a head mountable device such as smart glasses in some examples). For example, the first device may include communication circuitry (e.g., communication circuitry 215) for receiving wired or wireless transmissions from the second device, and/or transmitting wired or wireless transmissions (e.g., control signals, translated audio data and/or media content for output by a speaker of the second device) to the second device.

At block 1006, the first device (e.g., the input controller 400 and/or the condition detector 406) may control, based on the first microphone signal and the second microphone signal, an audio input to a translator application (e.g., translator application 402) at the first device, the translator application configured to generate an audio translation (e.g., translated audio data), from a first language (e.g., of a person 201 other than a user 101 of the first device and the second device) to a second language (e.g., of the user 101), of voice content (e.g., voice 222) in the audio input.

For example, at least one of the first microphone signal or the second microphone signal may include a representation of a voice (e.g., voice 222) of person (e.g., person 201), other than a user (e.g., user 101) of the first device, speaking in the first language, and the process 1000 may also include generating, with the translator application responsive to the controlled audio input, an audio output (e.g., translated audio data) that includes (e.g., a representation of) a voice (e.g., a computer-generated voice) speaking in the second language. For example, the voice speaking in the second language may be a computer-generated voice, and the first device may select the computer-generated voice from among multiple computer-generated voices that are stored at the first device. For example, the first device may select the computer-generated voice from among the multiple computer-generated voices based on the voice of (e.g., voice 222) of the person speaking in the first language. For example, the first device may determine that the voice of the person speaking in the first language is a low voice, a high voice, and/or a voice with a particular accent (e.g., corresponding to the first language). The first device may select one of the multiple computer-generated voices that sounds similar to (e.g., is a high voice, a low voice, and/or has the same or similar accent) the voice of the person speaking in the first language.

In one or more use cases controlling the audio input at block 1006 may include selecting (e.g., by the condition detector 406, such as by operating the switch 404) the first microphone signal or the second microphone signal as the audio input based at least in part on a signal-to-noise ratio of the first microphone signal (e.g., if the signal-to-noise ratio of one of the microphone signals is low, the device may select the other microphone signal for input to the translator application). In one or more other use cases, controlling the audio input may include determining (e.g., by the condition detector 406) whether to provide any audio input to the translator application based at least in part on a determination of whether a voice (e.g., voice 324) of a user (e.g., user 101) of the first device is present (e.g., if VAD1 = 1) in the second microphone signal. For example, determining whether to provide any audio input to the translator application based at least in part on based at least in part on the determination of whether the voice of the user of the first device is present in the second microphone signal may include providing at least one of the first microphone signal or the second microphone signal as the audio input to the translator application based on a first determination, at a first time (e.g., between T2 and T3 or between T6 and T7 of FIGS. 5A, 6 and 8), that the voice of the user of the first device is not present in the second microphone signal, and determining that no audio input (e.g., null input 410) is to be provided to the translator application based on a second determination, at a second time (e.g., between T3 and T5 or between T7 and T8 of FIGS. 5A, 6 and 8), that the voice of the user of the first device is present in the second microphone signal. In this example, no translation is generated when the user is speaking. However, in other examples, the translation may continue (e.g., by providing at least one of the first microphone signal or the second microphone signal as the audio input to the translator application) even when the user is speaking, and the translated audio output may be ducked or blurred so that the user can hear a reduced version of the translation while the user is speaking.

For example, in one or more implementations, the second microphone signal from the second device may include a multi-stream signal that includes: an own-voice stream configured to enhance a representation of the voice of a user (e.g., user 101) of the first device, and a target voice stream configured to enhance a representation of a voice (e.g., voice 222) of a person (e.g., person 201), other than the user of the first device. In this example, selecting the first microphone signal or the second microphone signal as the audio input based at least in part on the signal-to-noise ratio of the first microphone signal may include selecting, irrespective of whether the representation of the voice of the user of the first device is present in the first microphone signal or the own voice stream of the second microphone signal, the first microphone signal or the target voice stream of the second microphone signal as the audio input based at least in part on the signal-to-noise ratio of the first microphone signal. For example, at least one of the first microphone signal or the target voice stream of the second microphone signal may include the representation of the voice of person, other than the user of the first device, speaking in the first language, and the process 1000 may also include generating, with the first device and based on the audio input, a spatialized audio output that includes a voice speaking in the second language and configured to be perceived as emanating from a location of the person other than the user of the first device.

In one or more use cases, controlling the audio input may include selecting (e.g., by the condition detector 406 and/or the switch 404) the first microphone signal or the second microphone signal as the audio input based at least in part on a condition (e.g., an obstructed condition or an unobstructed condition) of the first device. For example, the first device (e.g., the condition detector 406) may determine the condition of the first device using a sensor signal from at least one sensor (e.g., sensor(s) 218) at the first device. For example, the at least one sensor may include a proximity sensor or an orientation sensor (e.g., an IMU sensor of the IMU 411, such as a gyroscope, an accelerometer or a magnetometer). For example, determining the condition of the first device may include determining whether the first microphone of the first device is obstructed. In one or more implementations, the first device (e.g., the condition detector 406) may determine the condition of the first device based at least in part on a user input that launched the translator application and/or translation session (e.g., if the user provided an input to the first device to launch the translator application, the first device may determine that the first device is likely unobstructed because the user is interacting with the first device). In one or more use cases, controlling the audio input may include selecting (e.g., the condition detector 406 and/or the switch 404) the first microphone signal or the second microphone signal as the audio input based at least in part on a state of the translator application at the first device. For example, the state of the translator application may include a state (e.g., a foreground state, an active state, a background state, a minimized state) of a user interface (e.g., user interface 900) of the translator application. In one or more use cases, the first device may provide a prompt (e.g., notification 902, or an audio or haptic notification) to move the first device (e.g., toward the person for whom translation is desired) based at least in part on the second microphone signal from the second device.

In one or more use cases, the translator application may also generate, based on the second microphone signal from the second device, a translation (e.g., translated user audio signal) of a voice (e.g., voice 324) of a user (e.g., user 101) of the first device, from the second language to the first language, for output by a speaker (e.g., speaker 216) of the first device. The first device (e.g., echo canceller 700) may also perform an echo cancellation operation on the first microphone signal from the first device prior to providing the first microphone signal to the translator application for translation of a voice (e.g., voice 222) of a person (e.g., person 201) other than the user from the first language to the second language.

In accordance with aspects of the subject technology, an electronic device (e.g., electronic device 104) is provided that includes a first microphone (e.g., a microphone 214); a memory (e.g., memory 212) storing a translator application (e.g., translator application 402) that is configured to generate an audio translation, from a first language to a second language, of voice content in an audio input; and one or more processors configured to: obtain a first microphone signal from the first microphone; obtain a second microphone signal from a second microphone (e.g., microphone 206) of an audio device (e.g., audio device 150) that is separate from the electronic device; and control, based on the first microphone signal and the second microphone signal, the audio input to the translator application. The electronic device may also include communication circuitry (e.g., communication circuitry 215). At least one of the first microphone signal or the second microphone signal may include a representation of a voice (e.g., voice 324) of person (e.g., person 201), other than a user (e.g., user 101) of the electronic device, speaking in the first language, and the one or more processors may be further configured to: receive the first microphone signal wirelessly from the audio device using the communication circuitry; generate, with the translator application responsive to the controlled audio input, an audio output comprising a computer-generated voice speaking in the second language; and provide, using the communication circuitry, the audio output to the audio device for output of the computer-generated voice by a speaker (e.g., speaker 152) of the audio device.

In one or more implementations, the memory stores voice characteristics (e.g., tone, pitch, accent, etc.) of a plurality of computer-generated voices, and the one or more processors may be further configured to select the computer-generated voice from among the plurality of computer-generated voices based at least in part on the voice of the person in the first microphone signal or the second microphone signal (e.g., by selecting one of the computer-generated voices that has similar voice characteristics to the voice characteristics of the voice of the person speaking the first language).

In one or more implementations, the one or more processors may be configured to control the audio input by selecting the first microphone signal or the second microphone signal as the audio input based at least in part on a sound pressure level (SPL) in the first microphone signal. As another example, the one or more processors may be configured to control the audio input by determining whether to provide any audio input (e.g., or a null input 410) to the translator application based at least in part on a determination of whether a voice (e.g., voice 324) of a user (e.g., user 101) of the electronic device is present in the second microphone signal.

In accordance with aspects of the subject technology, a system is provided that includes an audio device (e.g., audio device 150) that includes a first microphone (e.g., microphone 206); and an electronic device (e.g., electronic device 104) that includes a second microphone (e.g., microphone 214). The audio device may be configured to transmit, to the electronic device, a first microphone signal from the first microphone, and the electronic device may be configured to: obtain a second microphone signal from the second microphone; and control, based on the first microphone signal and the second microphone signal, an audio input to a translator application at the electronic device, the translator application configured to generate an audio translation, from a first language to a second language, of voice content in the audio input.

As discussed herein, in some use cases, the translation operations described herein may be used for translation of a performance (e.g., an opera, a play, a musical, a concert, a movie, or the like). For example, FIG. 11 is a flow chart of an example process 1100 for performance translation in accordance with one or more implementations of the subject technology. For explanatory purposes, the process 1100 is primarily described herein with reference to the audio device 150 and electronic device 104 described in connection with FIGS. 1-9. However, the process 1100 is not limited to the audio device 150 and electronic device 104 described in connection with FIGS. 1-9, and one or more blocks (or operations) of the process 1100 may be performed by one or more other components of other suitable devices, including the electronic device 110, the electronic device 115, and/or the servers 120. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

At block 1102, an audio input corresponding to a performance (e.g., an opera, a play, a musical, a concert, a movie, or the like) may be obtained with at least one microphone (e.g., one or more microphones 206 and/or one or more microphones 214) of a device (e.g., audio device 150 and/or electronic device 104) during the performance. For example, the user 101 may be in the audience of the performance and wearing and/or in possession of the audio device 150 and/or the electronic device 104. The audio input may include speech in a first language and ambient sounds. For example, the speech may include speech from a character in the performance, and the ambient sounds may include at least one of: other speech of other characters in the performance or music.

At block 1104, during the performance, a translation of the speech in a second language may be obtained (e.g., generated locally at the device or obtained from another device), such as from the translator application 402 described herein. For example, the first device may include an audio device such as an earbud, and obtaining the translation of the speech in the second language may include: providing at least a portion (e.g., a single stream of target voice buffers or multiple streams of multiple voice buffers) of the audio input from the earbud to a companion device; and receiving a computer-generated voice speaking the translation of the speech in the second language from the companion device. In another example, the audio device may generate the translation locally at the audio device.

In one or more implementations, the process 1100 may also include removing (e.g., filtering, suppressing, or cancelling) the speech in the first language from the audio output (e.g., the speech in the first language may be removed from the audio output). In one or more other implementations, the audio output may include a modified version of the speech in the first language (e.g., the process 1100 may include modifying the speech in the first language in the audio output). For example, the process 1100 may also include generating (e.g., at the device or the other device) the modified version of the speech in the first language by reducing a volume of the speech in the first language and/or by blurring the speech in the first language. For example, the modified version of the speech in the first language may include a reduced-volume version of the speech in the first language and/or a blurred version of the speech in the first language.

At block 1106, during the performance and with at least one speaker (e.g., one or more speakers 152) of the device, an audio output may be output. The audio output may include the ambient sounds and a computer-generated voice speaking the translation of the speech in the second language (e.g., as obtained from the translator application at block 1104).

In one or more implementations, the speech in the first language may be spoken by a character in the performance at a location in a physical environment of the device (e.g., a location on a stage or on a movie screen), and the process 1100 may also include determining, prior to the outputting, the location of the character in the physical environment of the device; and spatializing, according to the location, the computer-generated voice speaking the translation of the speech. For example, outputting the audio output with the at least one speaker at block 1106 may cause the spatialized computer-generated voice speaking the translation of the speech to be perceivable as emanating or originating from the location of the character. In one or more implementations, the process 1100 may also include determining, prior to the outputting, one or more characteristics of a voice of the character; and voice matching computer-generated voice speaking the translation of the speech to the one or more characteristics of the voice of the character. For example, the computer-generated voice speaking the translation of the speech may be spatialized according to the location and/or the computer-generated voice speaking the translation of the speech may be voice-matched to one or more characteristics of the voice of the character.

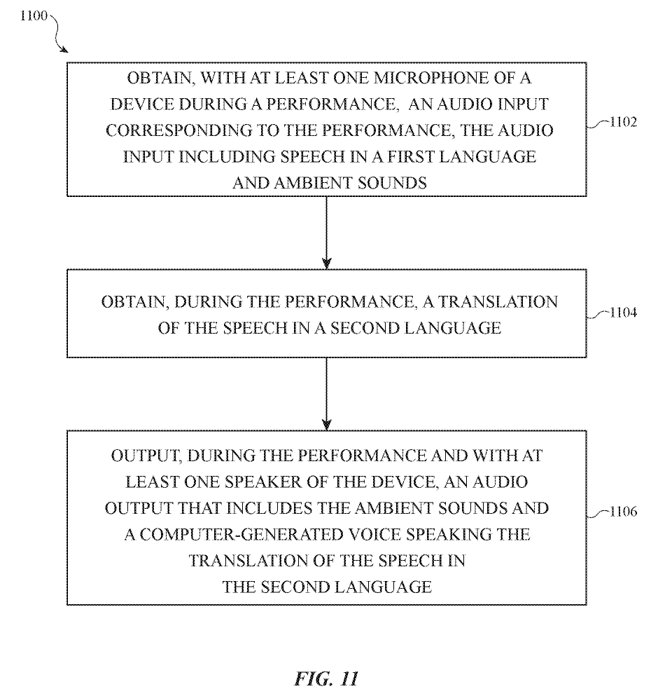

As discussed herein, in various use cases, it may be beneficial to be able to enhance the speech of one or more people speaking within a dynamically adjustable “field-of-view” (FOV) of a microphone array. This can be useful for generating audio inputs to a translator application and/or for electronically passing the speech (e.g., untranslated) through a headphone or earphone to the ears of a user. FIGS. 12A and 12B illustrate aspects of an example of dynamic control of a field-of-view of a beam for processing microphone signals in accordance with one or more implementations of the subject technology. In the example of FIGS. 12A and 12B, a top-down schematic view is shown of the user 101 engaged in conversation with the person 201 (e.g., which may be detectable by the audio device 150 and/or the electronic device 104 based on an attention vector 1200 for the user 101 and an attention vector 1202 for the person 201 being directed toward or approximately toward each other, as determined using a camera with a visual FOV 1208 and/or using the microphones of the audio device 150 to detect a direction of arrival of the voice of the person 201). In this example, the attention vector 1200 for the user 101 and the attention vector 1202 for the person 201 may indicate the respective directions in which the user 101 and the person 201 are looking or facing and/or the respective directions in which the user 101 and the person 201 are speaking. In this example, another person 1204 is present in the physical environment of the user 101 and the person 201, and is talking and/or facing in a direction 1205 away from the user 101. For example, the other person 1204 may be engaged in conversation with one or more additional people.

As shown in FIG. 12A, the field-of-view 1206 (e.g., defined by an angular boundary, such as extending between a first angular limit θ₁ and a second angular limit θ₂) of the microphones 206 of the audio device 150 may include the location of the person 201 at a time when the user 101 is looking and/or talking in the direction of the person 201. FIG. 12B illustrates how the FOV 1206 can be dynamically adjusted based on the location of the person 201, the location of the other person 1204, and the motion of the audio device 150 (e.g., as indicated by a change in the attention vector 1200). In the example of FIG. 12B, the size (e.g., the angular size, Δθ, between the first angular limit θ₁ and the second angular limit θ₂) of the FOV 1206 and the center of the FOV 1206 are adjusted, responsive to the motion of the device, so that, throughout a period of time (e.g., when the user 101 and the person 201 are engaged in conversation), the person 201 remains within the FOV 1206 while excluding the location of the person 1204 from the field-of-view 1206. In the example of FIG. 12B, the second angular limit θ₂ grows more than the first angular limit θ₁, due to the rotation of the device in the direction of the angular limit θ₂ and due to the presence of the person 1204 that is not involved in the conversation with the user 101. In this way, the beam having the FOV 1206 can be used to process the microphone signals to enhance the voice of the person 201 and suppress the voice of the person 1204.

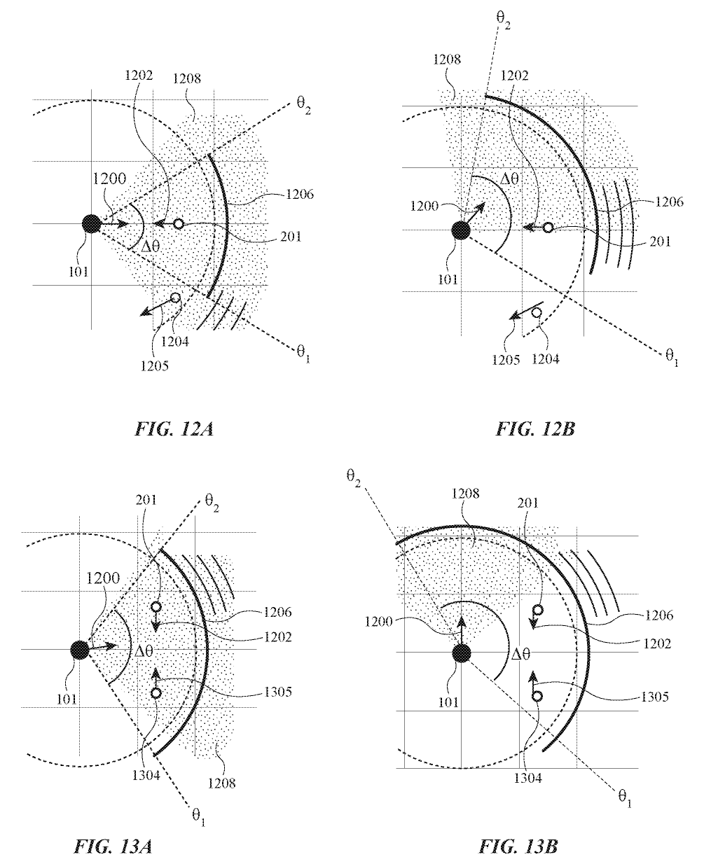

FIGS. 13A and 13B illustrate aspects of another example of dynamic control of a field-of-view of a beam for processing microphone signals in accordance with one or more implementations of the subject technology. In the example of FIGS. 13A and 13B, the person 201 is engaged in conversation with a person 1304 and the user 101 is attending to the conversation (e.g., which may be detectable by the audio device 150 and/or the electronic device 104 based on an attention vector 1200 for the user 101, an attention vector 1202 for the person 201, and/or an attention vector 1305 for the person 1304, as determined using a camera with a visual FOV 1208 and/or using the microphones of the audio device 150 to detect direction of arrival of the voices of the person 201 and the person 1304). The user 101 may be an active participant in the conversation between the person 201 and the person 1304, or may be a passive listener to the conversion (with the explicit permission of the person 201 and the person 1304).

As shown in FIG. 13A, the field-of-view 1206 of the microphones 206 of the audio device 150 may include the location of the person 201 and the location of the person 1304 at a time when the user 101 is looking and/or talking in a direction approximately toward the person 201 and the person 1304. FIG. 13B illustrates how the FOV 1206 can be dynamically adjusted based on the location of the person 201, the location of the other person 1304, and the motion of the audio device 150 (e.g., as indicated by a change in the attention vector 1200). In the example of FIG. 13B, the size (e.g., the angular size, Δθ, between the first angular limit θ₁ and the second angular limit θ₂) and the center of the FOV 1206 are adjusted, responsive to the motion of the device, so that, throughout a period of time (e.g., when the user 101 is present for the conversation between the person 201 and the person 1304), the person 201 and the person 1304 remain within the FOV 1206. In the example of FIG. 13B, the second angular limit θ₂ grows more than the first angular limit θ₁ due to the rotation of the device in the direction of the angular limit θ₂ and the operation to keep the person 1304 within the FOV 1206. In this way, the beam having the FOV 1206 may be used to enhance the voices of the person 201 and the person 1304 and suppress the sounds and/or other voices outside the FOV 1206.

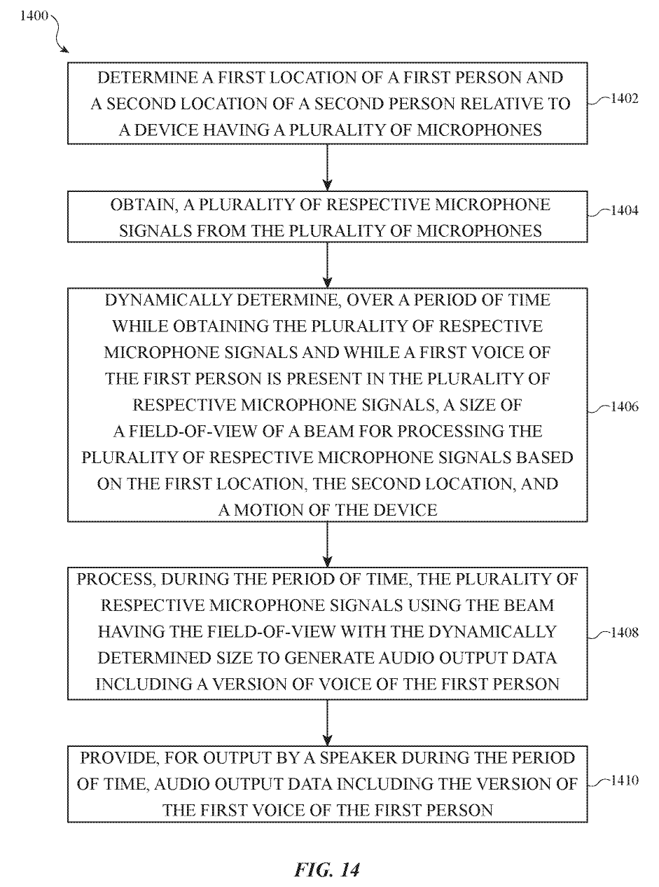

FIG. 14 is a flow chart of an example process 1400 for dynamic control of a field-of-view of a beam for processing microphone signals in accordance with one or more implementations of the subject technology. For explanatory purposes, the process 1400 is primarily described herein with reference to the audio device 150 and electronic device 104 described in connection with FIGS. 1-9 and 12A-13B. However, the process 1400 is not limited to the audio device 150 and electronic device 104 described in connection with FIGS. 1-9 and 12A-13B, and one or more blocks (or operations) of the process 1400 may be performed by one or more other components of other suitable devices, including the electronic device 110, the electronic device 115, and/or the servers 120. Further for explanatory purposes, some of the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

At block 1402, a first location of a first person (e.g., person 201) and a second location of a second person (e.g., person 1204 or person 1304) may be determined (e.g., by the audio device 150 and/or the electronic device 104) relative to a device (e.g., the audio device 150 and/or the electronic device 104) having a plurality of microphones (e.g., microphones 206 and/or microphones 214). Determining the first location and/or the second location may include determining the first location and/or the second location based on a direction of arrival at the device of a voice of the first person and/or the second person, and/or based on one or more images of the physical environment of the first person and the second person (e.g., as captured by one or more cameras of the device and/or another device).

At block 1404, a plurality of respective microphone signals may be obtained from the plurality of microphones. The microphone signals may be obtained while one or both of the first person and the second person are speaking in one or multiple languages.

At block 1406, a size (e.g., Δθ) of a field-of-view (e.g., FOV 1206) of a beam for processing the plurality of respective microphone signals may be dynamically determined (e.g., by the device having the microphones or by a companion device to which the microphone signals are provided), over a period of time while obtaining the plurality of respective microphone signals and while a first voice of the first person is present in the plurality of respective microphone signals, based on the first location, the second location, and a motion of the device (e.g., as determined by one or more inertial sensors of the device, such as accelerometers, gyroscopes, and/or magnetometers). In one or more implementations, an orientation or direction of the beam may also be dynamically determined.

At block 1408, the plurality of respective microphone signals may be processed (e.g., by the device having the microphones and/or by a companion device to which the microphone signals are provided), during the period of time, using the beam having the field-of-view with the dynamically determined size to generate audio output data including a version of voice of the first person.

At block 1410, audio output data including the version of the first voice of the first person may be provided, for output by a speaker (e.g., a speaker of the device having the microphones) during the period of time. The audio output data may be generated at the device having the speaker and/or by another device (e.g., the companion device) and provided to the device having the speaker. In one or more implementations, the audio output data may be spatialized for spatial output by multiple speakers.

In some examples (e.g., in the example of FIGS. 12A and 12B), the field-of-view includes the first location of the first person throughout the period of time, and dynamically determining the size of the field-of-view of the beam based on the first location, the second location, and the motion of the device includes expanding the size of the field-of-view, responsive to the motion of the device, while excluding the second location from the field-of-view. For example, dynamically determining the size of the field-of-view of the beam based on the first location, the second location, and the motion of the device may include dynamically determining the size of the field-of-view of the beam based on the first location, the second location, the motion of the device, and an indication (e.g., attention vector 1200, attention vector 1202, an image of the user and/or the first person, and/or a direction of arrival of the voice of the first person) that a user of the device is engaged in conversation with the first person. In some examples, the second person is engaged in conversation with a third person during the period of time.

In some examples (e.g., in the example of FIGS. 13A and 13B), dynamically determining the size of the field-of-view of the beam based on the first location, the second location, and the motion of the device may include expanding the size of the field-of-view, responsive to the motion of the device, while maintaining the first location and the second location within the field-of-view. For example, the first person and the second person may be engaged in a conversation with each other and/or with a user of the device.

In some examples, the version of the first voice of the first person includes a pass-through reproduction of the first voice of the first person (e.g., untranslated). In other examples, the version of the first voice of the first person may include a computer-generated voice speaking a translation of the first voice of the first person.

Aspects of the subject technology may improve the efficiency, accuracy, and/or latency of electronically generated translations of speech that are generated in substantially real time with the speech itself. For example, switching the input of a translator application between multiple microphones of one or more devices that are in different physical locations relative to the person speaking can help to provide more accurate translations. As another example, pausing translation operations (e.g., by pausing providing input signals to the translator application when the user of the electronic device is speaking) can help to reduce the processing and/or battery power used by the electronic device. Accordingly, these and other aspects of the subject technology, when implemented by one or more electronic devices, such as a smartphone and one or more audio devices, can provide improvements to other technologies (e.g., electronic translations) and to functioning of the computing devices on which those other technologies are implemented.

As described above, one aspect of the present technology is the gathering and use of data available from specific and legitimate sources for performing microphone switching for translation. The present disclosure contemplates that in some instances, this gathered data may include personal information data that uniquely identifies or can be used to identify a specific person. Such personal information data can include voice samples, voice profiles, demographic data, location-based data, online identifiers, telephone numbers, email addresses, home addresses, biometric data or records relating to a user’s health or level of fitness (e.g., vital signs measurements, medication information, exercise information, motion information, breathing information, heart rate information), date of birth, or any other personal information.

The present disclosure recognizes that the use of such personal information data, in the present technology, can be used to the benefit of users. For example, the personal information data can be used for performing microphone switching for translation.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of performing microphone switching for translation, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

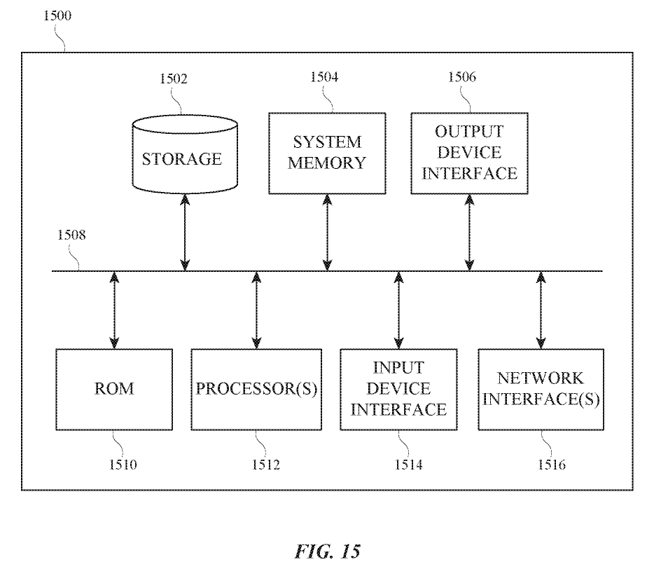

FIG. 15 illustrates an electronic system 1500 with which one or more implementations of the subject technology may be implemented. The electronic system 1500 can be, and/or can be a part of, the audio device 150, the electronic device 104, the electronic device 110, the electronic device 115, and/or the server 120 as shown in FIG. 1. The electronic system 1500 may include various types of computer readable media and interfaces for various other types of computer readable media. The electronic system 1500 includes a bus 1508, one or more processing unit(s) 1512, a system memory 1504 (and/or buffer), a ROM 1510, a permanent storage device 1502, an input device interface 1514, an output device interface 1506, and one or more network interfaces 1516, or subsets and variations thereof.

The bus 1508 collectively represents all system, peripheral, and chipset buses that communicatively connect the numerous internal devices of the electronic system 1500. In one or more implementations, the bus 1508 communicatively connects the one or more processing unit(s) 1512 with the ROM 1510, the system memory 1504, and the permanent storage device 1502. From these various memory units, the one or more processing unit(s) 1512 retrieves instructions to execute and data to process in order to execute the processes of the subject disclosure. The one or more processing unit(s) 1512 can be a single processor or a multi-core processor in different implementations.

The ROM 1510 stores static data and instructions that are needed by the one or more processing unit(s) 1512 and other modules of the electronic system 1500. The permanent storage device 1502, on the other hand, may be a read-and-write memory device. The permanent storage device 1502 may be a non-volatile memory unit that stores instructions and data even when the electronic system 1500 is off. In one or more implementations, a mass-storage device (such as a magnetic or optical disk and its corresponding disk drive) may be used as the permanent storage device 1502.

In one or more implementations, a removable storage device (such as a floppy disk, flash drive, and its corresponding disk drive) may be used as the permanent storage device 1502. Like the permanent storage device 1502, the system memory 1504 may be a read-and-write memory device. However, unlike the permanent storage device 1502, the system memory 1504 may be a volatile read-and-write memory, such as random access memory. The system memory 1504 may store any of the instructions and data that one or more processing unit(s) 1512 may need at runtime. In one or more implementations, the processes of the subject disclosure are stored in the system memory 1504, the permanent storage device 1502, and/or the ROM 1510 (which are each implemented as a non-transitory computer-readable medium). From these various memory units, the one or more processing unit(s) 1512 retrieves instructions to execute and data to process in order to execute the processes of one or more implementations.

The bus 1508 also connects to the input and output device interfaces 1514 and 1506. The input device interface 1514 enables a user to communicate information and select commands to the electronic system 1500. Input devices that may be used with the input device interface 1514 may include, for example, alphanumeric keyboards and pointing devices (also called “cursor control devices”). The output device interface 1506 may enable, for example, the display of images generated by electronic system 1500. Output devices that may be used with the output device interface 1506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 15, the bus 1508 also couples the electronic system 1500 to one or more networks and/or to one or more network nodes, such as the electronic device 150 shown in FIG. 1, through the one or more network interface(s) 1516. In this manner, the electronic system 1500 can be a part of a network of computers (such as a LAN, a wide area network (“WAN”), or an Intranet, or a network of networks, such as the Internet. Any or all components of the electronic system 1500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A method, comprising:
obtaining a first microphone signal from a first microphone of a first device;
obtaining, by the first device, a second microphone signal from a second microphone of a second device; and
controlling, by the first device based on the first microphone signal and the second microphone signal, an audio input to a translator application at the first device, the translator application configured to generate an audio translation, from a first language to a second language, of voice content in the audio input.

2. The method of claim 1, wherein at least one of the first microphone signal or the second microphone signal comprises a representation of a voice of person, other than a user of the first device, speaking in the first language, and wherein the method further comprises generating, with the translator application responsive to the controlled audio input, an audio output comprising a voice speaking in the second language.

3. The method of claim 1, wherein controlling the audio input comprises selecting the first microphone signal or the second microphone signal as the audio input based at least in part on a signal-to-noise ratio of the first microphone signal.

4. The method of claim 3, wherein the second microphone signal from the second device comprises a multi-stream signal that includes:
an own voice stream configured to enhance a representation of the voice of a user of the first device, and
a target voice stream configured to enhance a representation of a voice of a person, other than the user of the first device, and
wherein selecting the first microphone signal or the second microphone signal as the audio input based at least in part on the signal-to-noise ratio of the first microphone signal comprises selecting, irrespective of whether the representation of the voice of the user of the first device is present in the first microphone signal or the own voice stream of the second microphone signal, the first microphone signal or the target voice stream of the second microphone signal as the audio input based at least in part on the signal-to-noise ratio of the first microphone signal.

5. The method of claim 4, wherein at least one of the first microphone signal or the target voice stream of the second microphone signal comprises the representation of the voice of person, other than the user of the first device, speaking in the first language, and wherein the method further comprises generating, with the first device and based on the audio input, a spatialized audio output comprising a voice speaking in the second language and configured to be perceived as emanating from a location of the person other than the user of the first device.

6. The method of claim 1, wherein controlling the audio input comprises determining whether to provide any audio input to the translator application based at least in part on a determination of whether a voice of a user of the first device is present in the second microphone signal.

7. The method of claim 6, wherein determining whether to provide any audio input to the translator application based at least in part on the determination of whether the voice of the user of the first device is present in the second microphone signal comprises:
providing at least one of the first microphone signal or the second microphone signal as the audio input to the translator application based on a first determination, at a first time, that the voice of the user of the first device is not present in the second microphone signal; and
determining that no audio input is to be provided to the translator application based on a second determination, at a second time, that the voice of the user of the first device is present in the second microphone signal.

8. The method of claim 1, wherein controlling the audio input comprises selecting the first microphone signal or the second microphone signal as the audio input based at least in part on a condition of the first device.

9. The method of claim 8, further comprising determining the condition of the first device using a sensor signal from at least one sensor at the first device, wherein the at least one sensor comprises a proximity sensor or an orientation sensor, and wherein determining the condition of the first device further comprises determining whether the first microphone of the first device is obstructed.

10. The method of claim 8, further comprising determining the condition of the first device based at least in part on a user input that launched the translator application.

11. The method of claim 1, wherein controlling the audio input comprises selecting the first microphone signal or the second microphone signal as the audio input based at least in part on a state of a user interface of the translator application at the first device.

12. The method of claim 11, wherein the second device is a head mountable device.

13. The method of claim 1, further comprising providing, by the first device, a prompt to move the first device based at least in part on the second microphone signal from the second device.

14. The method of claim 1, further comprising:
generating, with the translator application based on the second microphone signal from the second device, a translation of a voice of a user of the first device, from the second language to the first language, for output by a speaker of the first device; and
performing an echo cancellation operation on the first microphone signal from the first device prior to providing the first microphone signal to the translator application for translation of a voice of a person other than the user from the first language to the second language.

15. An electronic device, comprising:
a first microphone;
a memory storing a translator application that is configured to generate an audio translation, from a first language to a second language, of voice content in an audio input; and
one or more processors configured to:
obtain a first microphone signal from the first microphone;
obtain a second microphone signal from a second microphone of an audio device that is separate from the electronic device; and
control, based on the first microphone signal and the second microphone signal, the audio input to the translator application.

16. The electronic device of claim 15, further comprising communication circuitry, wherein at least one of the first microphone signal or the second microphone signal comprises a representation of a voice of person, other than a user of the electronic device, speaking in the first language, and wherein the one or more processors are further configured to:
receive the first microphone signal wirelessly from the audio device using the communication circuitry;
generate, with the translator application responsive to the controlled audio input, an audio output comprising a computer-generated voice speaking in the second language; and
provide, using the communication circuitry, the audio output to the audio device for output of the computer-generated voice by a speaker of the audio device.

17. The electronic device of claim 16, wherein the memory stores voice characteristics of a plurality of computer-generated voices, and wherein the one or more processors are further configured to select the computer-generated voice from among the plurality of computer-generated voices based at least in part on the voice of the person in the first microphone signal or the second microphone signal.

18. The electronic device of claim 15, wherein the one or more processors are configured to control the audio input by selecting the first microphone signal or the second microphone signal as the audio input based at least in part on a sound pressure level in the first microphone signal.

19. The electronic device of claim 15, wherein the one or more processors are configured to control the audio input by determining whether to provide any audio input to the translator application based at least in part on a determination of whether a voice of a user of the electronic device is present in the second microphone signal.

20. A system, comprising:
an audio device comprising a first microphone; and
an electronic device comprising a second microphone, wherein the audio device is configured to transmit, to the electronic device, a first microphone signal from the first microphone, and wherein the electronic device is configured to:
obtain a second microphone signal from the second microphone; and
control, based on the first microphone signal and the second microphone signal, an audio input to a translator application at the electronic device, the translator application configured to generate an audio translation, from a first language to a second language, of voice content in the audio input.
